(19) United States
(12) Patent Application Publication
(10) Pub. No.: US 2024/0214999 A1
(43) Pub. Date: Jun. 27, 2024

(54) METHOD AND DEVICE IN NODES USED FOR WIRELESS COMMUNICATION

(71) Applicants: Qi JIANG, Shanghai (CN); Xiaobo ZHANG, Shanghai (CN)

(72) Inventors: Qi JIANG, Shanghai (CN); Xiaobo ZHANG, Shanghai (CN)

(73) Assignee: SHANGHAI LANGBO COMMUNICATION TECHNOLOGY COMPANY LIMITED, Shanghai (CN)

(21) Appl. No.: 18/595,460

(22) Filed: Mar. 5, 2024

Related U.S. Application Data
(63) Continuation of application No. PCT/CN2022/116418, filed on Sep. 9, 2021.

(30) Foreign Application Priority Data
Sep. 9, 2021 (CN) 202111054068.4

(51) Int. Cl. H04W 72/0446; H04W 72/0453; H04W 72/1273; H04W 76/20

(52) U.S. Cl. CPC H04W 72/0446; H04W 72/0453; H04W 72/1273; H04W 76/20

(57) ABSTRACT

A node receives a first information block, the first information block indicating a first value; then receives a first signal in a first time-frequency resource set, a transmit power value of the first signal being a first power value; a time-domain resource occupied by the first time-frequency resource set is a first time unit, a frequency-domain resource occupied by the first time-frequency resource set belongs to a first sub-band; at least one of a slot format corresponding to the first time unit or a relation of the first sub-band and a target sub-band is used to determine whether the first value is used to determine the first power value; configuration information for the target sub-band is used to at least determine a slot format for the target sub-band. Application improves the power value of downlink transmitted signal in flexible duplex mode to avoid interference and thereby optimize system performance.

### CROSS REFERENCE TO RELATED APPLICATIONS

This application is the continuation of the international patent application No. PCT/CN2022/1168418, filed on Sep. 1,2022, and claims the priority benefit of Chinese Patent Application No. 202111054068.4, filed on Sep. 9,2021, the full disclosure of which is incorporated herein by reference.

### BACKGROUND

### TECHNICAL FIELD

The present application relates to transmission methods and devices in wireless communication systems, and in particular to a transmission scheme and device for flexible transmission direction configurations in wireless communications.

### RELATED ART

Application scenarios of future wireless communication systems are becoming increasingly diversified, and different application scenarios have different performance demands on systems. In order to meet different performance requirements of various application scenarios, the 3rd Generation Partner Project (3GPP) Radio Access Network (RAN) #72 plenary decided to conduct the study of New Radio (NR), or what is called fifth Generation (5G). The work Item (WI) of NR was approved at the 3GPP RAN #75 session to standardize the NR. It was decided at the 3GPP RAN #86 Plenary that the Study Item (SI) and the Work Item (WI) of NR Rel-17 should be started, and the SI and WI of NR Rel-18 are expected to be proposed at the 3GPP RAN #94e plenary.

Enhanced Mobile BroadBand (eMBB), Ultra-reliable and Low Latency Communications (URLLC) and massive Machine Type Communications (mMTC) are three major application scenarios in New Radio (NR) technology. In the NR Rel-16 system, a major difference compared to the LTE (i.e., Long-Term Evolution) and LTE-A (i.e., Enhanced Long-Term Evolution) frame structures is that the symbols in a slot can be configured as Downlink, Uplink, or Flexible. For a symbol configured as “Flexible”, the terminal receives downlink transmissions on that symbol, and that symbol can also be used for uplink scheduling. The above approach is more flexible than LTE and LTE-A systems.

### SUMMARY

In the existing NR system, spectrum resources are statically divided into FDD spectrum and TDD spectrum. As for TDD spectrum, both the base station and the UE work in Half Duplex Mode. Such Half Duplex Mode avoids self-interference and reduces the influence of Cross Link interference, but it also brings about a reduction of resource utilization ratio and a longer delay. In view of these problems, to support flexible duplex mode or variable link directions (Uplink, or Downlink, or Flexible ones) on the TDD spectrum or the FDD spectrum becomes a possible solution.

As the uplink and downlink configurations in the system become more flexible, especially for base stations, downlink and uplink transmissions are performed simultaneously on different bands in the same time slot. However, in existing Vehicle-to-Everything (V2X) services, the base station tends to allocate a portion of the uplink resources for the transmission of V2X services. If there is overlapping resource between uplink resources used for V2X transmission and frequency-domain resources configured as “flexible”, or if there is cross-link interference between them, when the resources configured as “flexible” are used for downlink transmission in the cellular network, the so-called downlink transmission will cause interference to the reception of V2X signals, and corresponding solutions need to be considered.

To address the issue of configuration of the link direction in cases supporting Flexible Duplex Mode, the present application provides a solution. It should be noted that in the description of the present application, the flexible duplex mode is only used as a typical application scenario or example; the present application is equally applicable to other scenarios facing similar problems (e.g., scenarios in which there is a change in the link direction or other scenarios supporting multi-stage configuration of the transmission direction or scenarios with a more capable base station or user equipment, such as scenarios supporting full-duplex on the same frequency, or for different application scenarios, such as eMBB and URLLC, where similar technical results can be achieved). Additionally, the adoption of a unified solution for various scenarios, including but not limited to eMBB and URLLC scenarios, contributes to the reduction of hardcore complexity and costs. In the case of no conflict, the embodiments of a first node and the characteristics in the embodiments may be applied to a second node, and vice versa. Particularly, for interpretations of the terminology, nouns, functions and variables (unless otherwise specified) in the present application, refer to definitions given in TS36 series, TS38 series and TS37 series of 3GPP specifications.

The present application provides a method in a first node for wireless communications, comprising:
receiving a first information block, the first information block indicating a first value; and
receiving a first signal in a first time-frequency resource set, a transmit power value of the first signal being a first power value;
herein, a time-domain resource occupied by the first time-frequency resource set is a first time unit, and a frequency-domain resource occupied by the first time-frequency resource set belongs to a first sub-band; at least one of a slot format corresponding to the first time unit or a relation of the first sub-band and a target sub-band is used to determine whether the first value is used to determine the first power value; configuration information for the target sub-band is used to at least determine a slot format for the target sub-band.

In one embodiment, a technical feature of the above method is that when the slot format corresponding to the first time unit is flexible, the transmit power value of downlink signals sent in the first time unit will be reduced by the first value, thereby avoiding that when the first time unit is configured as a V2X resource for other terminals, the downlink signals sent in the first time unit will cause interference to the V2X reception of other terminals.

In one embodiment, another technical feature of the above method is that when there is an overlap between the first sub-band and the target sub-band and the target sub-band supports a flexible duplex mode, the transmit power value of downlink signals sent in the first time unit will be reduced by the first value, thereby avoiding that when the first time unit is configured as a V2X resource for other terminals, the downlink signals sent in the first time unit will interfere with the V2X reception of the other terminals.

According to one aspect of the present application, comprising:
receiving a second signal in a second time-frequency resource set;
herein, a transmit power value of the second signal is a second power value, the second power value being linear with both the first power value and the first value; a frequency-domain resource occupied by the second time-frequency resource set belongs to the first sub-band, and a time-domain resource occupied by the second time-frequency resource set is a second time unit, the second time unit and the first time unit being orthogonal in time domain; the first signal and the second signal occupy a same type of physical layer channel.

In one embodiment, a technical feature of the above method is that the above operation of reducing the transmit power value by means of the first value is carried out only in the first signal, i.e., for other signals of the same type, such as the second signal, the transmission is still carried out by means of transmitting without reduction of the power value, in order to ensure downlink coverage.

According to one aspect of the present application, comprising:
receiving a second information block;
herein, the second information block is used to indicate the configuration information for the target sub-band, the slot format for the target sub-band includes the target sub-band supporting transmissions in multiple links, or the slot format for the target sub-band includes symbols in the target sub-band supporting a flexible or variable duplex slot format.

In one embodiment, a technical feature of the above method is that the slot format of the target sub-band is configured by means of the second information block, i.e., the target sub-band is capable of supporting a flexible duplex mode, and thus the target sub-band can be configured for V2X transmission.

According to one aspect of the present application, comprising:
receiving a third information block;
herein, the third information block is used to indicate the slot format corresponding to the first time unit.

According to one aspect of the present application, the slot format corresponding to the first time unit is used to determine whether the first value is used to determine the first power value; when the slot format corresponding to the first time unit supports flexible or variable duplex, the first value is used to determine the first power value; when the slot format corresponding to the first time unit does not support flexible or variable duplex, the first value is not used to determine the first power value.

According to one aspect of the present application, the relation of the first sub-band and the target sub-band is used to determine whether the first value is used to determine the first power value; a frequency-domain location of the target sub-band is used to determine a second sub-band; when there is an overlap between the first sub-band and the second sub-band, the first value is used to determine the first power value; when there is no overlap between the first sub-band and the second sub-band, the first value is not used to determine the first power value.

According to one aspect of the present application, the second information block is configured per sub-band, a bandwidth of a frequency-domain resource occupied by the sub-band in frequency domain being smaller than that of a frequency-domain resource occupied by a bandwidth part.

According to one aspect of the present application, comprising:
receiving a synchronization signal;
receiving a third signal in a third time-frequency resource set; and
receiving a fourth signal in a fourth time-frequency resource set;
herein, a frequency-domain resource occupied by the third time-frequency resource set and a frequency-domain resource occupied by the fourth time-frequency resource set both belong the first sub-band; a time-domain resource occupied by the third time-frequency resource set is the first time unit, while a time-domain resource occupied by the fourth time-frequency resource set is the second time unit; each of the first signal and the second signal comprises a channel state information reference signal (CSI-RS), and each of a physical layer channel occupied by the third signal and a physical layer channel occupied by the fourth signal comprises a physical downlink shared channel (PDSCH); an EPRE of the synchronization signal, a first offset value and the first value are used to determine an EPRE of the first signal; the EPRE of the synchronization signal and the first offset value are used to determine an EPRE of the second signal, and the first value is not used to determine the EPRE of the second signal; the EPRE of the first signal and a second offset value are used to determine an EPRE of the third signal, and the EPRE of the second signal and the second offset value are used to determine an EPRE of the fourth signal; a radio resource control(RRC) signaling is used to determine the first offset value and the second offset value.

In one embodiment, a technical feature of the above method is that when the first signal and the second signal are both CSI-RS (i.e., Channel-State Information Reference Signals) and the third signal and the fourth signal are PDSCHs (i.e., Physical Downlink Shared Channels), the relationship between the EPRE (i.e., Energy Per Resource Element) of the existing PDSCH and the EPRE of the CSI-RS remains unchanged, namely, when the CSI-RS reduces the transmit power by the first value, the PDSCH located in the same slot or symbol also reduces the transmit power by the first value; when the CSI-RS does not reduce the transmit power by the first value, the PDSCH located in the same slot or symbol does not need to reduce the transmit power either.

According to one aspect of the present application, comprising:
transmitting a target information block;
herein, the target information block comprises channel quality information, and both the first signal and the second signal are used to determine the channel quality information; when the first signal is used to determine the channel quality information, the first node assumes that the transmit power value of the first signal is equal to the second power value.

In one embodiment, a technical feature of the above method is that when the first node calculates CSI (i.e., Channel-State Information) by means of the first signal, the transmit power value which is suppressed by means of the first value should not be calculated for the receive power value of the first signal, namely., the receive power value of the first signal used for calculating the CSI should be ramped up by the power value corresponding to the first value compared with the actual receive power value.

According to one aspect of the present application, the target sub-band supports transmissions of V2X.

In one embodiment, a technical feature of the above method is that when V2X transmission is supported in the target sub-band, only downlink signals transmitted in the first time-frequency resource set need to be reduced in transmit power to avoid interference with V2X signals transmitted in the target sub-band.

The present application provides a method in a second node for wireless communications, comprising:
transmitting a first information block, the first information block indicating a first value; and
transmitting a first signal in a first time-frequency resource set, a transmit power value of the first signal being a first power value;
herein, a time-domain resource occupied by the first time-frequency resource set is a first time unit, and a frequency-domain resource occupied by the first time-frequency resource set belongs to a first sub-band; at least one of a slot format corresponding to the first time unit or a relation of the first sub-band and a target sub-band is used to determine whether the first value is used to determine the first power value; configuration information for the target sub-band is used to at least determine a slot format for the target sub-band.

According to one aspect of the present application, comprising:
transmitting a second signal in a second time-frequency resource set;
herein, a transmit power value of the second signal is a second power value, the second power value being linear with both the first power value and the first value; a frequency-domain resource occupied by the second time-frequency resource set belongs to the first sub-band, and a time-domain resource occupied by the second time-frequency resource set is a second time unit, the second time unit and the first time unit being orthogonal in time domain; the first signal and the second signal occupy a same type of physical layer channel.

According to one aspect of the present application, comprising:
transmitting a second information block;
herein, the second information block is used to indicate the configuration information for the target sub-band, the slot format for the target sub-band includes the target sub-band supporting transmissions in multiple links, or the slot format for the target sub-band includes symbols in the target sub-band supporting a flexible or variable duplex slot format.

According to one aspect of the present application, comprising:
transmitting a third information block;
herein, the third information block is used to indicate the slot format corresponding to the first time unit.

According to one aspect of the present application, the slot format corresponding to the first time unit is used to determine whether the first value is used to determine the first power value; when the slot format corresponding to the first time unit supports flexible or variable duplex, the first value is used to determine the first power value; when the slot format corresponding to the first time unit does not support flexible or variable duplex, the first value is not used to determine the first power value.

According to one aspect of the present application, the relation of the first sub-band and the target sub-band is used to determine whether the first value is used to determine the first power value; a frequency-domain location of the target sub-band is used to determine a second sub-band; when there is an overlap between the first sub-band and the second sub-band, the first value is used to determine the first power value; when there is no overlap between the first sub-band and the second sub-band, the first value is not used to determine the first power value.

According to one aspect of the present application, the second information block is configured per sub-band, a bandwidth of a frequency-domain resource occupied by the sub-band in frequency domain being smaller than that of a frequency-domain resource occupied by a bandwidth part.

According to one aspect of the present application, comprising:
transmitting a synchronization signal;
transmitting a third signal in a third time-frequency resource set; and
transmitting a fourth signal in a fourth time-frequency resource set;
herein, a frequency-domain resource occupied by the third time-frequency resource set and a frequency-domain resource occupied by the fourth time-frequency resource set both belong the first sub-band; a time-domain resource occupied by the third time-frequency resource set is the first time unit, while a time-domain resource occupied by the fourth time-frequency resource set is the second time unit; each of the first signal and the second signal comprises a channel state information reference signal (CSI-RS), and each of a physical layer channel occupied by the third signal and a physical layer channel occupied by the fourth signal comprises a physical downlink shared channel (PDSCH); an EPRE of the synchronization signal, a first offset value and the first value are used to determine an EPRE of the first signal; the EPRE of the synchronization signal and the first offset value are used to determine an EPRE of the second signal, and the first value is not used to determine the EPRE of the second signal; the EPRE of the first signal and a second offset value are used to determine an EPRE of the third signal, and the EPRE of the second signal and the second offset value are used to determine an EPRE of the fourth signal; a radio resource control (RRC) signaling is used to determine the first offset value and the second offset value.

According to one aspect of the present application, comprising:
receiving a target information block;
herein, the target information block comprises channel quality information, and both the first signal and the second signal are used to determine the channel quality information; when the first signal is used to determine the channel quality information, the first node assumes that the transmit power value of the first signal is equal to the second power value.

According to one aspect of the present application, the target sub-band supports transmissions of V2X.

The present application provides a first node for wireless communications, comprising:
a first receiver, receiving a first information block, the first information block indicating a first value; and
a first transceiver, receiving a first signal in a first time-frequency resource set, a transmit power value of the first signal being a first power value;
herein, a time-domain resource occupied by the first time-frequency resource set is a first time unit, and a frequency-domain resource occupied by the first time-frequency resource set belongs to a first sub-band; at least one of a slot format corresponding to the first time unit or a relation of the first sub-band and a target sub-band is used to determine whether the first value is used to determine the first power value; configuration information for the target sub-band is used to at least determine a slot format for the target sub-band.

The present application provides a second node for wireless communications, comprising:
a first transmitter, transmitting a first information block, the first information block indicating a first value; and
a second transceiver, transmitting a first signal in a first time-frequency resource set, a transmit power value of the first signal being a first power value;
herein, a time-domain resource occupied by the first time-frequency resource set is a first time unit, and a frequency-domain resource occupied by the first time-frequency resource set belongs to a first sub-band; at least one of a slot format corresponding to the first time unit or a relation of the first sub-band and a target sub-band is used to determine whether the first value is used to determine the first power value; configuration information for the target sub-band is used to at least determine a slot format for the target sub-band.

In one embodiment, compared with the prior art, the present application is advantageous in the following aspects:
when the slot format corresponding to the first time unit is flexible, the transmit power value of downlink signals sent in the first time unit will be reduced by the first value, thus avoiding that when the first time unit is configured as a V2X resource for other terminals, downlink signals sent in the first time unit will interfere with the V2X reception of the other terminals;
when there is an overlap between the first sub-band and the target sub-band and the target sub-band supports flexible duplex mode, the transmit power value of the downlink signals sent in the first time unit will be reduced by the first value, thereby avoiding that when the first time unit is configured as a V2X resource for other terminals, the downlink signals sent in the first time unit will interfere with other terminals' V2X reception;
the operation of transmit power value reduction by means of the first value is performed only in the first signal, namely, for other signals of the same type, such as the second signal, they are still transmitted in a way without reducing the power value, in order to ensure downlink coverage;
the method in the present application does not change the existing relationship between the EPRE of the PDSCH and the EPRE of the CSI-RS, namely, when the CSI-RS reduces the transmit power by the first value, the PDSCH located in the same slot or symbol also reduces the transmit power by the first value; when the CSI-RS does not reduce the transmit power by the first value, the PDSCH located in the same slot or PDSCH located in the same slot or symbol is not required to reduce the transmit power either;
when the first node calculates the CSI by means of the first signal, the above mentioned transmitted power value which is suppressed by means of the first value should not be calculated into the receive power value of the first signal, namely, the receive power value of the first signal used for the calculation of the CSI should be ramped up by the power value corresponding to the first value compared with the actual receive power value.

### BRIEF DESCRIPTION OF THE DRAWINGS

Other features, objects and advantages of the present application will become more apparent from the detailed description of non-restrictive embodiments taken in conjunction with the following drawings:

FIG. 1 illustrates a flowchart of processing of a first node according to one embodiment of the present application.

FIG. 2 illustrates a schematic diagram of a network architecture according to one embodiment of the present application.

FIG. 3 illustrates a schematic diagram of a radio protocol architecture of a user plane and a control plane according to one embodiment of the present application.

FIG. 4 illustrates a schematic diagram of a first communication device and a second communication device according to one embodiment of the present application.

FIG. 5 illustrates a flowchart of a first information block according to one embodiment of the present application.

FIG. 6 illustrates a flowchart of a second signal according to one embodiment of the present application.

FIG. 7 illustrates a flowchart of a second information block and a third information block according to one embodiment of the present application.

FIG. 8 illustrates a flowchart of a synchronization signal according to one embodiment of the present application.

FIG. 9 illustrates a flowchart of a target information block according to one embodiment of the present application.

FIG. 10 illustrates a schematic diagram of a target sub-band according to one embodiment of the present application.

FIG. 11 illustrates a schematic diagram of a target sub-band according to another embodiment of the present application.

FIG. 12 illustrates a schematic diagram of the slot format of a first time unit according to one embodiment of the present application.

FIG. 13 illustrates a schematic diagram of the slot format of a target sub-band according to one embodiment of the present application.

FIG. 14 illustrates a structure block diagram of a processing device in a first node according to one embodiment of the present application.

FIG. 15 illustrates a structure block diagram of a processing device in a second node according to one embodiment of the present application.

### DESCRIPTION OF THE EMBODIMENTS

The technical scheme of the present application is described below in further details in conjunction with the drawings. It should be noted that the embodiments of the present application and the characteristics of the embodiments may be arbitrarily combined if no conflict is caused.

### Embodiment 1

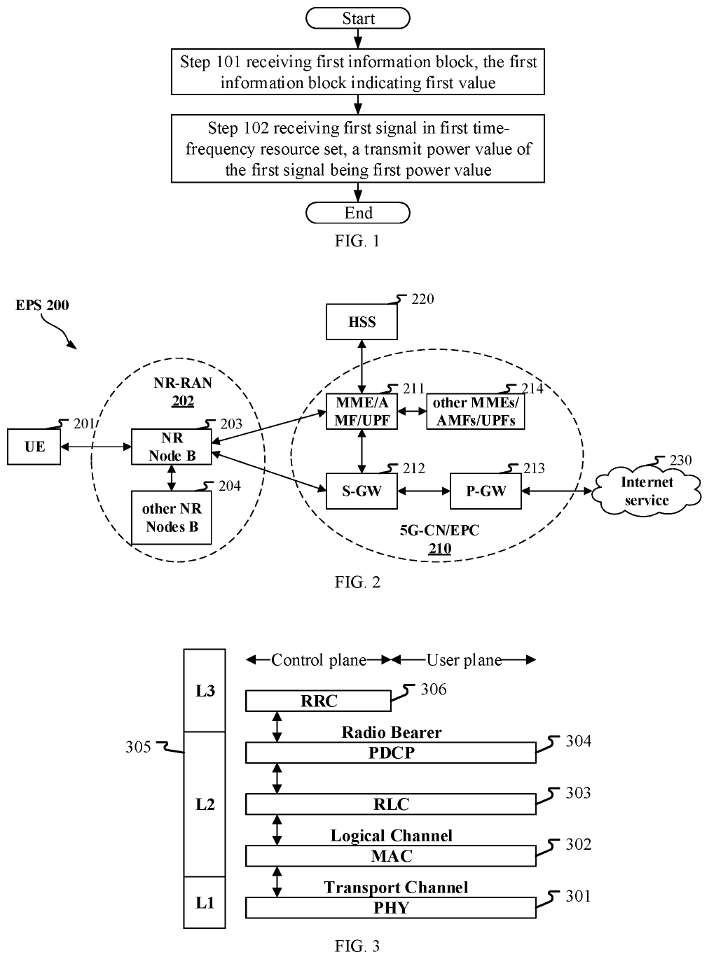

Embodiment 1 illustrates a flowchart of processing of a first node, as shown in FIG. 1. In 100 illustrated by FIG. 1, each box represents a step. In Embodiment 1, the first node in the present application receives a first information block in step 101, the first information block indicating a first value; and receives a first signal in a first time-frequency resource set in step 102, a transmit power value of the first signal being a first power value.

In Embodiment 1, a time-domain resource occupied by the first time-frequency resource set is a first time unit, and a frequency-domain resource occupied by the first time-frequency resource set belongs to a first sub-band; at least one of a slot format corresponding to the first time unit or a relation of the first sub-band and a target sub-band is used to determine whether the first value is used to determine the first power value; configuration information for the target sub-band is used to at least determine a slot format for the target sub-band.

In one embodiment, the first information block is transmitted via a Radio Resource Control (RRC) signaling.

In one embodiment, the first information block is transmitted via a Media Access Control (MAC) Control Element (CE).

In one embodiment, the first information block is transmitted via a physical layer dynamic signaling.

In one embodiment, the first information block is UE specific or UE dedicated.

In one embodiment, the first information block is Cell Common or Cell specific.

In one embodiment, the first information block is subband specific.

In one embodiment, the name of a higher layer signaling bearing the first information block includes Subband.

In one embodiment, the name of a higher layer signaling bearing the first information block includes Bandwidth Part (BWP).

In one embodiment, the name of a higher layer signaling bearing the first information block includes Power.

In one embodiment, the name of a higher layer signaling bearing the first information block includes Offset.

In one embodiment, the higher layer signaling in the present application comprises a MAC CE.

In one embodiment, the higher layer signaling in the present application comprises an RRC signaling.

In one embodiment, the first value is a real number

In one embodiment, the first value is measured in dB.

In one embodiment, the first value is used to determine an offset of a power value.

In one embodiment, the first time-frequency resource set comprises a positive integer number of Resource Elements (REs).

In one embodiment, the first time-frequency resource set comprises a positive integer number of subcarrier(s) in frequency domain, and the first time-frequency resource set comprises a positive integer number of symbol(s) in time domain.

In one embodiment, the symbol in the present application is an Orthogonal Frequency Division Multiplexing (OFDM) Symbol.

In one embodiment, the symbol in the present application is a Single Carrier- Frequency Division Multiple Access (SC-FDMA) symbol.

In one embodiment, the symbol in the present application is a Filter Bank Multi Carrier (FBMC) symbol.

In one embodiment, the symbol in the present application is an OFDM symbol containing a Cyclic Prefix (CP).

In one embodiment, the symbol in the present application is a Discrete Fourier Transform Spreading Orthogonal Frequency Division Multiplexing (DFT-s-OFDM) symbol containing CP.

In one embodiment, the first signal comprises a Physical Downlink Shared Channel (PDSCH).

In one embodiment, the first signal comprises a Physical Downlink Control Channel (PDCCH).

In one embodiment, a transport channel corresponding to the first signal includes a Downlink Shared Channel (DL-SCH).

In one embodiment, the first signal comprises a CSI-RS.

In one embodiment, the first signal comprises a Phase Tracking Reference Signal (PT-RS).

In one embodiment, the first power value is measured in dBm.

In one embodiment, the first power value is measured in mW.

In one embodiment, the first time unit is a symbol.

In one embodiment, the first time unit comprises more than one symbol.

In one embodiment, the first time unit is a slot.

In one embodiment, the first time unit comprises more than one slot.

In one embodiment, the first time unit is a Mini-Slot.

In one embodiment, the first time unit is a Sub-Slot.

In one embodiment, the frequency-domain bandwidth of the first sub-band is smaller than one BWP.

In one embodiment, a frequency-domain resource occupied by the first sub-band belongs to one BWP.

In one embodiment, the first sub-band occupies more than one subcarrier.

In one embodiment, the first sub-band occupies band resources corresponding to a positive integer number of Resource Blocks (RBs).

In one embodiment, the Slot Format corresponding to the first time unit is one of Downlink (“D”), Uplink (“U”) or Flexible (“F”).

In one embodiment, the meaning of the slot format corresponding to the first time unit includes: a slot format corresponding to all symbols comprised in the first time unit.

In one embodiment, the meaning of the slot format corresponding to the first time unit includes: a slot format corresponding to any symbol comprised in the first time unit.

In one embodiment, the meaning of the slot format corresponding to the first time unit includes: all symbols comprised in the first time unit are in one slot format.

In one embodiment, the meaning of the slot format being “D” in the present application includes: the time-domain resources corresponding to the slot format are used for downlink transmission.

In one embodiment, the meaning of the slot format being “U” in the present application includes: the time-domain resources corresponding to the slot format are used for uplink transmission.

In one embodiment, the meaning of the slot format being “F” in the present application includes: the time-domain resources corresponding to the slot format can be used not only for downlink transmission but also for uplink transmission.

In one embodiment, the slot format in the present application includes a number of uplink time-domain symbols and a number of downlink time-domain symbols in a slot.

In one embodiment, the slot format in the present application includes a number of uplink time-domain symbols and a number of downlink time-domain symbols in a slot as well as an order in which uplink and downlink time-domain symbols are sorted.

In one embodiment, the slot format in the present application is a distribution pattern of uplink and downlink time-domain symbols and flexible time-domain symbols.

In one embodiment, the slot format in the present application is a distribution pattern of uplink and downlink time-domain symbols and flexible time-domain symbols within a time period.

In one embodiment, the slot format in the present application is a distribution pattern of uplink and downlink time-domain symbols and flexible time-domain symbols within a time period, the distribution pattern being periodically repeated in time domain.

In one embodiment, the slot format in the present application includes a number of uplink time-domain symbols and a distribution pattern of downlink time-domain symbols in a slot.

In one embodiment, the slot format in the present application includes a number of and a distribution pattern of uplink and downlink time-domain symbols in a slot.

In one embodiment, the slot format in the present application includes a distribution pattern of uplink and downlink time-domain symbols and flexible time-domain symbols in a target time window.

In one subembodiment, the target time window is a slot.

In one subembodiment, the target time window is a subframe.

In one subembodiment, the target time window is 2 frames.

In one subembodiment, the target time window is pre-defined.

In one subembodiment, the target time window is explicitly or implicitly configured.

In one subembodiment, the distribution pattern of uplink and downlink time-domain symbols and flexible time-domain symbols in the target time window is periodically repeated.

In one embodiment, any time-domain symbol other than uplink and downlink time-domain symbols in a slot format is a flexible time-domain symbol.

In one embodiment, a relation between the first sub-band and the target sub-band includes: whether the first sub-band belongs to the target sub-band in frequency domain.

In one subembodiment, the first sub-band belongs to the target sub-band in frequency domain, the first value being used to determine the first power value; the first sub-band does not belong to the target sub-band in frequency domain, the first value being not used to determine the first power value.

In one embodiment, a relation between the first sub-band and the target sub-band includes: whether the first sub-band is orthogonal to the target sub-band in frequency domain.

In one subembodiment, the first sub-band is orthogonal to the target sub-band in frequency domain, the first value not being used to determine the first power value; the first sub-band is overlapping with the target sub-band in frequency domain, the first value being used to determine the first power value.

In one embodiment, a relation between the first sub-band and the target sub-band includes: whether there is at least one overlapping subcarrier in frequency domain between the first sub-band and the target sub-band.

In one subembodiment, there is at least one overlapping subcarrier in frequency domain between the first sub-band and the target sub-band, the first value being used to determine the first power value; there isn't any one overlapping subcarrier in frequency domain between the first sub-band and the target sub-band, the first value not being used to determine the first power value.

In one embodiment, a relation between the first sub-band and the target sub-band includes: whether each resource block included in the first sub-band in frequency domain belongs to the target sub-band.

In one subembodiment, each resource block included in the first sub-band in frequency domain belongs to the target sub-band, the first value being used to determine the first power value; at least one resource block included in the first sub-band in frequency domain does not belong to the target sub-band, the first value being not used to determine the first power value.

In one embodiment, a relation between the first sub-band and the target sub-band includes: a frequency-domain location of the target sub-band is used to determine a second sub-band and whether the first sub-band belongs to the second sub-band.

In one subembodiment, the first sub-band belongs to the second sub-band, the first value being used to determine the first power value; the first sub-band does not belong to the second sub-band, the first value being not used to determine the first power value.

In one embodiment, a relation between the first sub-band and the target sub-band includes: a frequency-domain location of the target sub-band is used to determine a second sub-band and whether there is at least one overlapping subcarrier in frequency domain between the first sub-band and the second sub-band.

In one subembodiment, there is an overlap between the first sub-band and the second sub-band, the first value being used to determine the first power value; there is no overlap between the first sub-band and the second sub-band, the first value being not used to determine the first power value.

In one embodiment, the meaning of the statement in the present application that the first sub-band is overlapping with the target sub-band includes: there exists at least one subcarrier belonging to both the first sub-band and the target sub-band.

In one embodiment, the meaning of the statement in the present application that the first sub-band is overlapping with the target sub-band includes: there exists at least one RB corresponding to frequency-domain resources belonging to both the first sub-band and the target sub-band.

In one embodiment, the meaning of the statement in the present application that there is an overlap between the first sub-band and the second sub-band includes: there exists at least one subcarrier belonging to both the first sub-band and the second sub-band.

In one embodiment, the meaning of the statement in the present application that there is an overlap between the first sub-band and the second sub-band includes: there exists at least one RB corresponding to frequency-domain resources belonging to both the first sub-band and the second sub-band.

In one embodiment, the slot format corresponding to the first time unit is used to determine whether the first value is used to determine the first power value.

In one embodiment, the relation between the first sub-band and the target sub-band is used to determine whether the first value is used to determine the first power value

In one embodiment, the slot format corresponding to the first time unit, and the relation between the first sub-band and the target sub-band are used together to determine whether the first value is used to determine the first power value.

In one embodiment, the statement that “configuration information for the target sub-band is used to at least determine a slot format for the target sub-band” in the claims includes the following meaning: the configuration information for the target sub-band is used by the first node in the present application to determine at least a slot format for the target sub-band.

In one embodiment, the statement that “configuration information for the target sub-band is used to at least determine a slot format for the target sub-band” in the claims includes the following meaning: part or all of the configuration information for the target sub-band is used to explicitly or implicitly indicate a slot format for the target sub-band.

In one embodiment, the statement that “configuration information for the target sub-band is used to at least determine a slot format for the target sub-band” in the claims includes the following meaning: the configuration information for the target sub-band comprises an indication of whether the target sub-band is a sub-band with Flexible Link (FL) or Variable Link (VL), and the indication of whether the target sub-band is a sub-band with FL or VL is used to determine a slot format for the target sub-band.

In one embodiment, the statement that “configuration information for the target sub-band is used to at least determine a slot format for the target sub-band” in the claims includes the following meaning: the configuration information for the target sub-band comprises an indication of whether a link direction of time-domain symbols configured as uplink or downlink by an IE “tdd-UL-DL-ConfigCommon” is supported in being overridden, and the indication of whether a link direction of time-domain symbols configured as uplink or downlink by an IE “tdd-UL-DL-ConfigCommon” is supported in being overridden is used to determine the slot format for the target sub-band.

In one embodiment, the statement that “configuration information for the target sub-band is used to at least determine a slot format for the target sub-band” in the claims includes the following meaning: the configuration information for the target sub-band comprises an indication of whether a link direction of time-domain symbols configured as uplink or downlink by an IE “tdd-UL-DL-ConfigDedicated” is supported in being overridden, and the indication of whether a link direction of time-domain symbols configured as uplink or downlink by an IE “tdd-UL-DL-ConfigDedicated” is supported in being overridden is used to determine the slot format for the target sub-band.

In one embodiment, the statement that “configuration information for the target sub-band is used to at least determine a slot format for the target sub-band” in the claims includes the following meaning: the configuration information for the target sub-band comprises an indication of whether the target sub-band supports multiple link directions, and the indication of whether the target sub-band supports multiple link directions is used to determine a slot format for the target sub-band.

In one embodiment, the Slot Format for the target sub-band includes a slot format applicable to the target sub-band.

In one embodiment, the Slot Format for the target sub-band includes a slot format that a transmission of a channel or a signal by which frequency-domain resources occupied belong to the target sub-band conforms to in time domain.

In one embodiment, the Slot Format for the target sub-band includes a slot format configured by configuration information specific or dedicated to the target sub-band.

In one embodiment, the Slot Format for the target sub-band includes a slot format that a time-domain symbol occupied by a transmission by which at least one sub-carrier occupied in frequency domain belongs to the target sub-band satisfies.

In one embodiment, the Slot Format for the target sub-band includes a link direction that a time-domain symbol occupied by a transmission by which at least one sub-carrier occupied in frequency domain belongs to the target sub-band satisfies.

In one embodiment, the Slot Format for the target sub-band includes a slot format satisfied by a link direction of a time-domain symbol occupied in time domain by a channel or a signal that has at least one subcarrier overlapped with the target sub-band in frequency domain.

In one embodiment, the Slot Format for the target sub-band is specific or dedicated to the target sub-band.

In one embodiment, a Slot Format for a sub-band other than the target sub-band may or may not be identical to a Slot Format for the target sub-band.

In one embodiment, whether a Slot Format for a sub-band other than the target sub-band is identical to a Slot Format for the target sub-band is up to the network-side configuration.

In one embodiment, the Slot Format for the target sub-band includes all slot formats for the target sub-band.

In one embodiment, the Slot Format for the target sub-band includes any slot format for the target sub-band.

In one embodiment, the slot format of the target sub-band is “D”, indicating that the target sub-band is configured for downlink transmissions only; the slot format of the target sub-band is “U”, indicating that the target sub-band is configured for uplink transmissions only; and the slot format of the target sub-band is “F”, indicating that the target sub-band can be configured not only for downlink transmissions, but for uplink transmissions as well.

In one subembodiment, the slot format of the target sub-band is for the first node.

In one subembodiment, the slot format of the target sub-band is for the second node in the present application.

In one embodiment, the first signal is a radio signal.

In one embodiment, the first signal is a baseband signal.

In one embodiment, the slot format in the present application refers to: the slot format used by a symbol in the slot.

In one embodiment, the slot format in the present application refers to: the direction of transmission corresponding to a symbol in the slot.

In one embodiment, the slot format in the present application refers to: the direction of transmission corresponding to a symbol in the slot is one of “downlink”, “uplink” or “flexible”.

In one embodiment, the slot format in the present application refers to: the direction of transmission corresponding to the slot.

In one embodiment, the slot format in the present application refers to: the direction of transmission corresponding to the slot is one of “downlink”, “uplink” or “flexible”.

### Embodiment 2

Embodiment 2 illustrates a schematic diagram of a network architecture, as shown in FIG. 2.

FIG. 2 is a diagram illustrating a network architecture 200 of 5G NR, Long-Term Evolution (LTE) and Long-Term Evolution Advanced (LTE-A) systems. The 5G NR or LTE network architecture 200 may be called an Evolved Packet System (EPS) 200 or other suitable terminology. The EPS 200 may comprise one UE 201, an NR-RAN 202, a Evolved Packet Core/5G-Core Network (EPC-5G-CN) 210, a Home Subscriber Server (HSS) 220 and an Internet Service 230. The EPS 200 may be interconnected with other access networks. For simple description, the entities/interfaces are not shown. As shown in FIG. 2, the EPS 200 provides packet switching services. Those skilled in the art will find it easy to understand that various concepts presented throughout the present application can be extended to networks providing circuit switching services or other cellular networks. The NR-RAN 202 comprises an NR node B (gNB) 203 and other gNBs 204. The gNB 203 provides UE 201 oriented user plane and control plane terminations. The gNB 203 may be connected to other gNBs 204 via an Xn interface (for example, backhaul). The gNB 203 may be called a base station, a base transceiver station, a radio base station, a radio transceiver, a transceiver function, a Base Service Set (BSS), an Extended Service Set (ESS), a Transmitter Receiver Point (TRP) or some other applicable terms. The gNB 203 provides an access point of the EPC/5G-CN 210 for the UE 201. Examples of UE 201 include cellular phones, smart phones, Session Initiation Protocol (SIP) phones, laptop computers, Personal Digital Assistant (PDA), Satellite Radios, non-terrestrial base station communications, satellite mobile communications, Global Positioning Systems (GPSs), multimedia devices, video devices, digital audio players (for example, MP3 players), cameras, games consoles, unmanned aerial vehicles, air vehicles, narrow-band physical network equipment, machine-type communication equipment, land vehicles, automobiles, wearable equipment, or any other devices having similar functions. Those skilled in the art also can call the UE 201 a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user proxy, a mobile client, a client or some other appropriate terms. The gNB 203 is connected to the EPC/5G-CN 210 via an S1/NG interface. The EPC/5G-CN 210 comprises a Mobility Management Entity (MME)/Authentication Management Field(AMF)/User Plane Function (UPF) 211, other MMEs/AMFs/UPFs 214, a Service Gateway (S-GW) 212 and a Packet Date Network Gateway (P-GW) 213. The MME/AMF/UPF 211 is a control node for processing a signaling between the UE 201 and the EPC/5G-CN 210. Generally, the MME/AMF/UPF 211 provides bearer and connection management. All user Internet Protocol (IP) packets are transmitted through the S-GW 212. The S-GW 212 is connected to the P-GW 213. The P-GW 213 provides UE IP address allocation and other functions. The P-GW 213 is connected to the Internet Service 230. The Internet Service 230 comprises IP services corresponding to operators, specifically including Internet, Intranet, IP Multimedia Subsystem (IMS) and Packet Switching Streaming (PSS) services.

In one embodiment, the UE 201 corresponds to the first node in the present application.

In one embodiment, the UE201 supports Unpaired Spectrum scenarios.

In one embodiment, the UE 201 supports Flexible Duplex frequency domain resource configuration.

In one embodiment, the UE 201 supports Full Duplex transmission.

In one embodiment, the UE 201 supports dynamic adjustment of uplink and downlink transmission directions.

In one embodiment, the UE 201 supports V2X transmission.

In one embodiment, the UE 201 supports the transmission of V2X based on network-side configuration resources.

In one embodiment, the gNB203 corresponds to the second node in the present application.

In one embodiment, the gNB203 supports Unpaired Spectrum scenarios.

In one embodiment, the gNB203 supports Flexible Duplex frequency domain resource configuration.

In one embodiment, the gNB203 supports Full Duplex transmission.

In one embodiment, the gNB203 supports dynamic adjustment of uplink and downlink transmission directions.

In one embodiment, the gNB203 supports V2X transmission.

In one embodiment, the gNB203 supports the transmission of V2X based on network-side configuration resources.

### Embodiment 3

Embodiment 3 illustrates a schematic diagram of a radio protocol architecture of a user plane and a control plane according to the present application, as shown in FIG. 3. FIG. 3 is a schematic diagram illustrating an embodiment of a radio protocol architecture of a user plane 350 and a control plane 300. In FIG. 3, the radio protocol architecture for a control plane 300 between a first communication node (UE, gNB or, RSU in V2X) and a second communication node (gNB, UE, or RSU in V2X) is represented by three layers, which are L1, L2 and L3. The layer 1 (L1) is the lowest layer which performs signal processing functions of various PHY layers. The L1 is called PHY 301 in the present application. The layer 2 (L2) 305 is above the PHY 301, and is in charge of the link between a first communication node and a second communication node via the PHY 301. The L2 305 comprises a Medium Access Control (MAC) sublayer 302, a Radio Link Control (RLC) sublayer 303 and a Packet Data Convergence Protocol (PDCP) sublayer 304. All these sublayers terminate at the second communication nodes. The PDCP sublayer 304 provides multiplexing among variable radio bearers and logical channels. The PDCP sublayer 304 provides security by encrypting packets and also support for inter-cell handover of the second communication node between first communication nodes. The RLC sublayer 303 provides segmentation and reassembling of a higher-layer packet, retransmission of a lost packet, and reordering of a packet so as to compensate the disordered receiving caused by Hybrid Automatic Repeat reQuest (HARQ). The MAC sublayer 302 provides multiplexing between a logical channel and a transport channel. The MAC sublayer 302 is also responsible for allocating between first communication nodes various radio resources (i.e., resource block) in a cell. The MAC sublayer 302 is also in charge of HARQ operation. In the control plane 300, the Radio Resouce Control (RRC) sublayer 306 in the L3 layer is responsible for acquiring radio resources (i.e., radio bearer) and configuring the lower layer using an RRC signaling between the second communication node and the first communication node. The radio protocol architecture in the user plane 350 comprises the L1 layer and the L2 layer. In the user plane 350, the radio protocol architecture used for the first communication node and the second communication node in a PHY layer 351, a PDCP sublayer 354 of the L2 layer 355, an RLC sublayer 353 of the L2 layer 355 and a MAC sublayer 352 of the L2 layer 355 is almost the same as the radio protocol architecture used for corresponding layers and sublayers in the control plane 300, but the PDCP sublayer 354 also provides header compression used for higher-layer packet to reduce radio transmission overhead. The L2layer 355 in the user plane 350 also comprises a Service Data Adaptation Protocol (SDAP) sublayer 356, which is in charge of the mapping between QoS streams and a Data Radio Bearer (DRB), so as to support diversified traffics. Although not described in FIG. 3, the first communication node may comprise several higher layers above the L2 355, such as a network layer (i.e., IP layer) terminated at a P-GW 213 of the network side and an application layer terminated at the other side of the connection (i.e., a peer UE, a server, etc.).

In one embodiment, the radio protocol architecture in FIG. 3 is applicable to the first node in the present application.

In one embodiment, the radio protocol architecture in FIG. 3 is applicable to the second node in the present application.

In one embodiment, the PDCP304 of the second communication node is used for generating scheduling of the first communication node.

In one embodiment, the PDCP354 of the second communication node is used for generating scheduling of the first communication node.

In one embodiment, the first information block is generated by the RRC 306.

In one embodiment, the first information block is generated by the MAC302 or the MAC352.

In one embodiment, the first information block is generated by the PHY 301 or the PHY 351.

In one embodiment, the first signal is generated by the PHY 301 or the PHY 351.

In one embodiment, the first signal is generated by the MAC302 or the MAC352.

In one embodiment, the first signal is generated by the RRC 306.

In one embodiment, the second signal is generated by the PHY 301 or the PHY 351.

In one embodiment, the second signal is generated by the MAC302 or the MAC352.

In one embodiment, the second signal is generated by the RRC 306.

In one embodiment, the second information block is generated by the RRC 306.

In one embodiment, the second information block is generated by the MAC302 or the MAC352.

In one embodiment, the second information block is generated by the PHY 301 or the PHY 351.

In one embodiment, the third information block is generated by the RRC 306.

In one embodiment, the third information block is generated by the MAC302 or the MAC352.

In one embodiment, the third information block is generated by the PHY 301 or the PHY 351.

In one embodiment, the synchronization signal is generated by the PHY 301 or the PHY 351.

In one embodiment, the third signal is generated by the RRC 306.

In one embodiment, the third signal is generated by the MAC302 or the MAC352.

In one embodiment, the fourth signal is generated by the RRC 306.

In one embodiment, the fourth signal is generated by the MAC302 or the MAC352.

In one embodiment, the target information block is generated by the RRC 306.

In one embodiment, the target information block is generated by the MAC302 or the MAC352.

In one embodiment, the target information block is generated by the PHY 301 or the PHY 351.

In one embodiment, the first node is a terminal.

In one embodiment, the second node is a terminal.

In one embodiment, the second node is a Transmitter Receiver Point (TRP).

In one embodiment, the second node is a cell.

In one embodiment, the second node is an eNB.

In one embodiment, the second node is a base station.

In one embodiment, the second node is used for managing multiple TRPs.

In one embodiment, the second node is used for managing multiple nodes of cells.

In one embodiment, the second node is used for managing multiple nodes of carriers.

### Embodiment 4

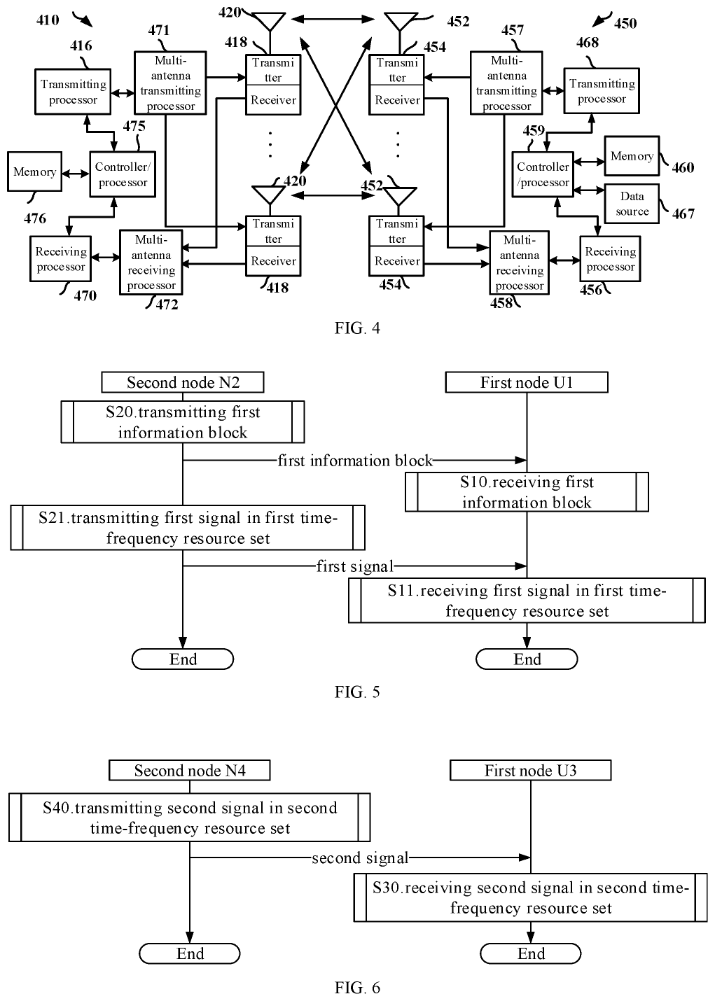

Embodiment 4 illustrates a schematic diagram of a first communication device and a second communication device according to the present application, as shown in FIG. 4. FIG. 4 is a block diagram of a first communication device 450 and a second communication device 410 in communication with each other in an access network.

The first communication device 450 comprises a controller/processor 459, a memory 460, a data source 467, a transmitting processor 468, a receiving processor 456, a multi-antenna transmitting processor 457, a multi-antenna receiving processor 458, a transmitter/receiver 454 and an antenna 452.

The second communication device 410 comprises a controller/processor 475, a memory 476, a receiving processor 470, a transmitting processor 416, a multi-antenna receiving processor 472, a multi-antenna transmitting processor 471, a transmitter/receiver 418 and an antenna 420.

In a transmission from the second communication device 410 to the first communication device 450, at the second communication device 410, a higher layer packet from a core network is provided to the controller/processor 475. The controller/processor 475 provides functions of the L2 layer. In the transmission from the second communication device 410 to the first communication device 450, the controller/processor 475 provides header compression, encryption, packet segmentation and reordering, and multiplexing between a logical channel and a transport channel, and radio resource allocation of the first communication device 450 based on various priorities. The controller/processor 475 is also in charge of a retransmission of a lost packet and a signaling to the first communication device 450. The transmitting processor 416 and the multi-antenna transmitting processor 471 perform various signal processing functions used for the L1 layer (i.e., PHY). The transmitting processor 416 performs coding and interleaving so as to ensure a Forward Error Correction (FEC) at the second communication device 410 side and the mapping to signal clusters corresponding to each modulation scheme (i.e., BPSK, QPSK, M-PSK, and M-QAM, etc.). The multi-antenna transmitting processor 471 performs digital spatial precoding, which includes precoding based on codebook and precoding based on non-codebook, and beamforming processing on encoded and modulated signals to generate one or more spatial streams. The transmitting processor 416 then maps each spatial stream into a subcarrier. The mapped symbols are multiplexed with a reference signal (i.e., pilot frequency) in time domain and/or frequency domain, and then they are assembled through Inverse Fast Fourier Transform (IFFT) to generate a physical channel carrying time-domain multicarrier symbol streams. After that the multi-antenna transmitting processor 471 performs transmission analog precoding/beamforming on the time-domain multicarrier symbol streams. Each transmitter 418 converts a baseband multicarrier symbol stream provided by the multi-antenna transmitting processor 471 into a radio frequency (RF) stream, which is later provided to different antennas 420.

In a transmission from the second communication device 410 to the first communication device 450, at the first communication device 450, each receiver 454 receives a signal via a corresponding antenna 452. Each receiver 454 recovers information modulated to the RF carrier, and converts the radio frequency stream into a baseband multicarrier symbol stream to be provided to the receiving processor 456. The receiving processor 456 and the multi-antenna receiving processor 458 perform signal processing functions of the L1 layer. The multi-antenna receiving processor 458 performs reception analog precoding/beamforming on a baseband multicarrier symbol stream provided by the receiver 454. The receiving processor 456 converts the processed baseband multicarrier symbol stream from time domain into frequency domain using FFT. In frequency domain, a physical layer data signal and a reference signal are de-multiplexed by the receiving processor 456, wherein the reference signal is used for channel estimation, while the data signal is subjected to multi-antenna detection in the multi-antenna receiving processor 458 to recover any first communication device 450-targeted spatial stream. Symbols on each spatial stream are demodulated and recovered in the receiving processor 456 to generate a soft decision. Then the receiving processor 456 decodes and de-interleaves the soft decision to recover the higher-layer data and control signal transmitted by the second communication device 410 on the physical channel. Next, the higher-layer data and control signal are provided to the controller/processor 459. The controller/processor 459 provides functions of the L2 layer. The controller/processor 459 can be associated with a memory 460 that stores program code and data. The memory 460 can be called a computer readable medium. In the transmission from the second communication device 410 to the second communication device 450, the controller/processor 459 provides demultiplexing between a transport channel and a logical channel, packet reassembling, decrypting, header decompression and control signal processing so as to recover a higher-layer packet from the core network. The higher-layer packet is later provided to all protocol layers above the L2 layer. Or various control signals can be provided to the L3 for processing.

In a transmission from the first communication device 450 to the second communication device 410, at the first communication device 450, the data source 467 is configured to provide a higher-layer packet to the controller/processor 459. The data source 467 represents all protocol layers above the L2 layer. Similar to a transmitting function of the second communication device 410 described in the transmission from the second communication node 410 to the first communication node 450, the controller/processor 459 performs header compression, encryption, packet segmentation and reordering, and multiplexing between a logical channel and a transport channel based on radio resource allocation so as to provide the L2 layer functions used for the user plane and the control plane. The controller/processor 459 is also responsible for a retransmission of a lost packet, and a signaling to the second communication device 410. The transmitting processor 468 performs modulation and mapping, as well as channel coding, and the multi-antenna transmitting processor 457 performs digital multi-antenna spatial precoding, including precoding based on codebook and precoding based on non-codebook, and beamforming. The transmitting processor 468 then modulates generated spatial streams into multicarrier/single-carrier symbol streams. The modulated symbol streams, after being subjected to analog precoding/beamforming in the multi-antenna transmitting processor 457, are provided from the transmitter 454 to each antenna 452. Each transmitter 454 firstly converts a baseband symbol stream provided by the multi-antenna transmitting processor 457 into a radio frequency symbol stream, and then provides the radio frequency symbol stream to the antenna 452.

In a transmission from the first communication device 450 to the second communication device 410, the function of the second communication device 410 is similar to the receiving function of the first communication device 450 described in the transmission from the second communication device 410 to the first communication device 450. Each receiver 418 receives a radio frequency signal via a corresponding antenna 420, converts the received radio frequency signal into a baseband signal, and provides the baseband signal to the multi-antenna receiving processor 472 and the receiving processor 470. The receiving processor 470 and the multi-antenna receiving processor 472 jointly provide functions of the L1 layer. The controller/processor 475 provides functions of the L2 layer. The controller/processor 475 can be associated with a memory 476 that stores program code and data. The memory 476 can be called a computer readable medium. In the transmission from the first communication device 450 to the second communication device 410, the controller/processor 475 provides de-multiplexing between a transport channel and a logical channel, packet reassembling, decrypting, header decompression, control signal processing so as to recover a higher-layer packet from the first communication device (UE) 450. The higher-layer packet coming from the controller/processor 475 may be provided to the core network.

In one embodiment, the first communication device 450 comprises at least one processor and at least one memory. The at least one memory comprises computer program codes; the at least one memory and the computer program codes are configured to be used in collaboration with the at least one processor. The first communication device 450 at least firstly receives a first information block, the first information block indicating a first value; and then receives a first signal in a first time-frequency resource set, a transmit power value of the first signal being a first power value; a time-domain resource occupied by the first time-frequency resource set is a first time unit, and a frequency-domain resource occupied by the first time-frequency resource set belongs to a first sub-band; at least one of a slot format corresponding to the first time unit or a relation of the first sub-band and a target sub-band is used to determine whether the first value is used to determine the first power value; configuration information for the target sub-band is used to at least determine a slot format for the target sub-band.

In one embodiment, the first communication device 450 comprises a memory that stores computer readable instruction program, the computer readable instruction program generates actions when executed by at least one processor, which include: firstly receiving a first information block, the first information block indicating a first value; and then receiving a first signal in a first time-frequency resource set, a transmit power value of the first signal being a first power value; a time-domain resource occupied by the first time-frequency resource set is a first time unit, and a frequency-domain resource occupied by the first time-frequency resource set belongs to a first sub-band; at least one of a slot format corresponding to the first time unit or a relation of the first sub-band and a target sub-band is used to determine whether the first value is used to determine the first power value; configuration information for the target sub-band is used to at least determine a slot format for the target sub-band.

In one embodiment, the second communication device 410 comprises at least one processor and at least one memory. The at least one memory comprises computer program codes; the at least one memory and the computer program codes are configured to be used in collaboration with the at least one processor. The second communication device 410 at least: firstly transmits a first information block, the first information block indicating a first value; and then transmits a first signal in a first time-frequency resource set, a transmit power value of the first signal being a first power value; a time-domain resource occupied by the first time-frequency resource set is a first time unit, and a frequency-domain resource occupied by the first time-frequency resource set belongs to a first sub-band; at least one of a slot format corresponding to the first time unit or a relation of the first sub-band and a target sub-band is used to determine whether the first value is used to determine the first power value; configuration information for the target sub-band is used to at least determine a slot format for the target sub-band.

In one embodiment, the second communication device 410 comprises a memory that stores computer readable instruction program, the computer readable instruction program generates actions when executed by at least one processor, which include: firstly transmitting a first information block, the first information block indicating a first value; and then transmitting a first signal in a first time-frequency resource set, a transmit power value of the first signal being a first power value; a time-domain resource occupied by the first time-frequency resource set is a first time unit, and a frequency-domain resource occupied by the first time-frequency resource set belongs to a first sub-band; at least one of a slot format corresponding to the first time unit or a relation of the first sub-band and a target sub-band is used to determine whether the first value is used to determine the first power value; configuration information for the target sub-band is used to at least determine a slot format for the target sub-band.

In one embodiment, the first communication device 450 corresponds to the first node in the present application.

In one embodiment, the second communication device 410 corresponds to a second node in the present application.

In one embodiment, the first communication device 450 is a UE.

In one embodiment, the first communication device 450 is a terminal.

In one embodiment, the second communication device 410 is a base station.

In one embodiment, the second communication device 410 is a UE.

In one embodiment, the second communication device 410 is network equipment.

In one embodiment, the second communication device 410 is a serving cell.

In one embodiment, the second communication device 410 is a TRP.

In one embodiment, at least the first four of the antenna 452, the receiver 454, the multi-antenna receiving processor 458, the receiving processor 456 and the controller/processor 459 are used for receiving a first information block, the first information block used to indicate a first value; at least the first four of the antenna 420, the transmitter 418, the multi-antenna transmitting processor 471, the transmitting processor 416 and the controller/processor 475 are used for transmitting a first information block, the first information block used to indicate a first value.

In one embodiment, at least the first four of the antenna 452, the receiver 454, the multi-antenna receiving processor 458, the receiving processor 456 and the controller/processor 459 are used for receiving a first signal in a first time-frequency resource set, a transmit power value of the first signal being a first power value; at least the first four of the antenna 420, the transmitter 418, the multi-antenna transmitting processor 471, the transmitting processor 416 and the controller/processor 475 are used for transmitting a first signal in a first time-frequency resource set, a transmit power value of the first signal being a first power value.

In one embodiment, at least the first four of the antenna 452, the receiver 454, the multi-antenna receiving processor 458, the receiving processor 456 and the controller/processor 459 are used for receiving a second signal in a second time-frequency resource set; at least the first four of the antenna 420, the transmitter 418, the multi-antenna transmitting processor 471, the transmitting processor 416 and the controller/processor 475 are used for transmitting a second signal in a second time-frequency resource set.

In one embodiment, at least the first four of the antenna 452, the receiver 454, the multi-antenna receiving processor 458, the receiving processor 456 and the controller/processor 459 are used for receiving a second information block; at least the first four of the antenna 420, the transmitter 418, the multi-antenna transmitting processor 471, the transmitting processor 416 and the controller/processor 475 are used for transmitting a second information block.

In one embodiment, at least the first four of the antenna 452, the receiver 454, the multi-antenna receiving processor 458, the receiving processor 456 and the controller/processor 459 are used for receiving a third information block; at least the first four of the antenna 420, the transmitter 418, the multi-antenna transmitting processor 471, the transmitting processor 416 and the controller/processor 475 are used for transmitting a third information block.

In one embodiment, at least the first four of the antenna 452, the receiver 454, the multi-antenna receiving processor 458, the receiving processor 456 and the controller/processor 459 are used for receiving a synchronization signal; at least the first four of the antenna 420, the transmitter 418, the multi-antenna transmitting processor 471, the transmitting processor 416 and the controller/processor 475 are used for transmitting a synchronization signal.

In one embodiment, at least the first four of the antenna 452, the receiver 454, the multi-antenna receiving processor 458, the receiving processor 456 and the controller/processor 459 are used for receiving a third signal in a third time-frequency resource set; at least the first four of the antenna 420, the transmitter 418, the multi-antenna transmitting processor 471, the transmitting processor 416 and the controller/processor 475 are used for transmitting a third signal in a third time-frequency resource set.

In one embodiment, at least the first four of the antenna 452, the receiver 454, the multi-antenna receiving processor 458, the receiving processor 456 and the controller/processor 459 are used for receiving a fourth signal in a fourth time-frequency resource set; at least the first four of the antenna 420, the transmitter 418, the multi-antenna transmitting processor 471, the transmitting processor 416 and the controller/processor 475 are used for transmitting a fourth signal in a fourth time-frequency resource set.

In one embodiment, at least the first four of the antenna 452, the transmitter 454, the multi-antenna transmitting processor 457, the transmitting processor 468 and the controller/processor 459 are used for transmitting a target information block; at least the first four of the antenna 420, the receiver 418, the multi-antenna receiving processor 472, the receiving processor 470 and the controller/processor 475 are used for receiving a target information block.

### Embodiment 5

Embodiment 5 illustrates a flowchart of a first information block, as shown in FIG. 5. In FIG. 5, a first node U1 and a second node N2 are in communication via a radio link. It should be particularly noted that the sequence illustrated herein does not set any limit to the signal transmission order or implementation order in the present application. In case of no conflict, the embodiments, subembodiments, and subsidiary embodiments in Embodiment 5 can be applied to any embodiment of Embodiments 6, 7, 8 and 9; conversely, in case of no conflict, the embodiments, subembodiments, and subsidiary embodiments in Embodiments 6, 7, 8 and 9 can be applied to Embodiment 5.

The first node U1 receives a first information block in step S10; and receives a first signal in a first time-frequency resource set in step S11.

The second node N2 transmits a first information block in step S20; and transmits a first signal in a first time-frequency resource set in step S21.

In Embodiment 5, the first information block is used to indicate a first value, a transmit power value of the first signal being a first power value; a time-domain resource occupied by the first time-frequency resource set is a first time unit, and a frequency-domain resource occupied by the first time-frequency resource set belongs to a first sub-band; at least one of a slot format corresponding to the first time unit or a relation of the first sub-band and a target sub-band is used to determine whether the first value is used to determine the first power value; configuration information for the target sub-band is used to at least determine a slot format for the target sub-band.

In one embodiment, the slot format corresponding to the first time unit is used to determine whether the first value is used to determine the first power value; when the slot format corresponding to the first time unit supports flexible or variable duplex, the first value is used to determine the first power value; when the slot format corresponding to the first time unit does not support flexible or variable duplex, the first value is not used to determine the first power value.

In one subembodiment, when the slot format corresponding to the first time unit supports flexible or variable duplex, the second power value is added to the first value to obtain the first power value; when the slot format corresponding to the first time unit does not support flexible or variable duplex, the second power value is equal to the first power value.

In one subembodiment, when the slot format corresponding to the first time unit supports flexible or variable duplex, the second power value is subtracted by the first value to obtain the first power value; when the slot format corresponding to the first time unit does not support flexible or variable duplex, the second power value is equal to the first power value.

In one embodiment, the relation of the first sub-band and the target sub-band is used to determine whether the first value is used to determine the first power value; a frequency-domain location of the target sub-band is used to determine a second sub-band; when there is an overlap between the first sub-band and the second sub-band, the first value is used to determine the first power value; when there is no overlap between the first sub-band and the second sub-band, the first value is not used to determine the first power value.

In one subembodiment, a first boundary frequency is equal to a lowest boundary frequency of the target sub-band, and a second boundary frequency is equal to a highest boundary frequency of the target sub-band; a first reference frequency is equal to the difference between the first boundary frequency and a target frequency gap length, and a second reference frequency is equal to the sum of the second boundary frequency and the target frequency gap length; the second sub-band is a frequency interval from the first reference frequency to the second reference frequency.

In one subembodiment, when there is an overlap between the first sub-band and the second sub-band, the second power value is added to the first value to obtain the first power value; when there is no overlap between the first sub-band and the second sub-band, the second power value is equal to the first power value.

In one subembodiment, when there is an overlap between the first sub-band and the second sub-band, the second power value is subtracted by the first value to obtain the first power value; when there is no overlap between the first sub-band and the second sub-band, the second power value is equal to the first power value.

In one embodiment, the frequency-domain location of the target sub-band is used to determine a second sub-band; when the slot format corresponding to the first time unit is flexible or variable duplex-supported and there is an overlap between the first sub-band and the second sub-band, the first value is used to determine the first power value; otherwise, the first value is not used to determine the first power value.

In one subembodiment, that the first value is used to determine the first power value means: the second power value being added to the first value to obtain the first power value.

In one subembodiment, that the first value is used to determine the first power value means: the second power value being subtracted by the first value to obtain the first power value.

In one subembodiment, that the first value is not used to determine the first power value means: the first value being unrelated to the first power value.

In one subembodiment, that the first value is not used to determine the first power value means: the second power value being equal to the first power value.

In one embodiment, the first time-frequency resource set is configured to be used for V2X transmission.

In one embodiment, the first time-frequency resource set is used by a node other than the first node U1 for V2X transmission.

### Embodiment 6

Embodiment 6 illustrates a flowchart of a second signal, as shown in FIG. 6. In FIG. 6, a first node U3 and a second node N4 are in communication via a radio link. It should be particularly noted that the sequence illustrated herein does not set any limit to the signal transmission order or implementation order in the present application. In case of no conflict, the embodiments, subembodiments, and subsidiary embodiments in Embodiment 6 can be applied to any embodiment of Embodiments 5, 7, 8 and 9; conversely, in case of no conflict, the embodiments, subembodiments, and subsidiary embodiments in Embodiments 5, 7, 8 and 9 can be applied to Embodiment 6.

The first node U3 receives a second signal in a second time-frequency resource set in step S30.

The second node N4 transmits a second signal in a second time-frequency resource set in step S40.

In Embodiment 6, a transmit power value of the second signal is a second power value, the second power value being linear with both the first power value and the first value; a frequency-domain resource occupied by the second time-frequency resource set belongs to the first sub-band, and a time-domain resource occupied by the second time-frequency resource set is a second time unit, the second time unit and the first time unit being orthogonal in time domain; the first signal and the second signal occupy a same type of physical layer channel.

In one embodiment, the second time-frequency resource set comprises a positive integer number of subcarrier(s) in frequency domain, and the second time-frequency resource set comprises a positive integer number of symbol(s) in time domain.

In one embodiment, the second signal comprises a PDSCH.

In one embodiment, a transport channel corresponding to the second signal includes a DL-SCH.

In one embodiment, the second signal comprises a PDCCH.

In one embodiment, the second signal comprises a CSI-RS.

In one embodiment, the second signal comprises a PT-RS.

In one embodiment, the second power value is measured in dBm.

In one embodiment, the second power value is measured in mW.

In one embodiment, the second power value is equal to a sum of the first power value and the first value.

In one embodiment, the first power value is equal to the difference obtained by subtracting the first value from the second power value.

In one embodiment, the phrase the second time unit and the first time unit being orthogonal in time domain includes a meaning that there does not exist a symbol belonging to both the second time unit and the first time unit.

In one embodiment, the phrase that the first signal and the second signal occupy a same type of physical layer channel includes a meaning that the physical layer channel occupied by the first signal and the physical layer channel occupied by the second signal are both PDSCHs.

In one embodiment, the phrase that the first signal and the second signal occupy a same type of physical layer channel includes a meaning that the physical layer channel occupied by the first signal and the physical layer channel occupied by the second signal are both PDCCHs.

In one embodiment, the phrase that the first signal and the second signal occupy a same type of physical layer channel includes a meaning that the reference signal included in the first signal and the reference signal included in the second signal are both CSI-RS.

In one embodiment, the phrase that the first signal and the second signal occupy a same type of physical layer channel includes a meaning that the reference signal included in the first signal and the reference signal included in the second signal are both PT-RS.

In one embodiment, the second signal is a radio signal.

In one embodiment, the second signal is a baseband signal.

In one embodiment, the step S30 in Embodiment 6 is located after the step S11 in Embodiment 5.

In one embodiment, the step S30 in Embodiment 6 is located before the step S11 in Embodiment 5.

In one embodiment, the step S40 in Embodiment 6 is located after the step S21 in Embodiment 5.

In one embodiment, the step S40 in Embodiment 6 is located before the step S21 in Embodiment 5.

### Embodiment 7

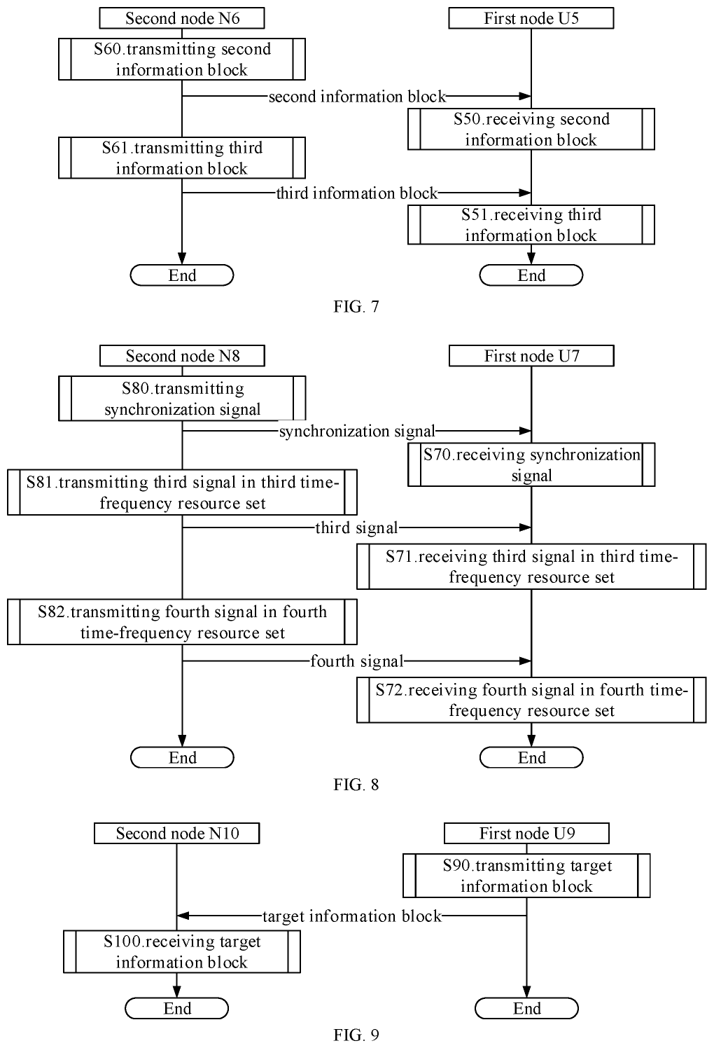

Embodiment 7 illustrates a flowchart of a second information block and a third information block, as shown in FIG. 7. In FIG. 7, a first node U5 and a second node N6 are in communication via a radio link. It should be particularly noted that the sequence illustrated herein does not set any limit to the signal transmission order or implementation order in the present application. In case of no conflict, the embodiments, subembodiments, and subsidiary embodiments in Embodiment 7 can be applied to any embodiment of Embodiments 5, 6, 8 and 9; conversely, in case of no conflict, the embodiments, subembodiments, and subsidiary embodiments in Embodiments 5, 6, 8 and 9 can be applied to Embodiment 7.

The first node U5 receives a second information block in step S50, and receives a third information block in step S51.

The second node N6 transmits a second information block in step S60, and transmits a third information block in step S61.

In Embodiment 7, the second information block is used to indicate the configuration information for the target sub-band, the slot format for the target sub-band includes the target sub-band supporting transmissions in multiple links, or the slot format for the target sub-band includes symbols in the target sub-band supporting a flexible or variable duplex slot format; the third information block is used to indicate the slot format corresponding to the first time unit.

In one embodiment, the step S51 is located before the step S51 and the step S61 is located before the step S60.

In one embodiment, the step S50 in Embodiment 7 is located after the step S10 in Embodiment 5.

In one embodiment, the step S50 in Embodiment 7 is located before the step S10 in Embodiment 5.

In one embodiment, the step S60 in Embodiment 7 is located after the step S20 in Embodiment 5.

In one embodiment, the step S60 in Embodiment 7 is located before the step S20 in Embodiment 5.

In one embodiment, the second information block comprises higher-layer information or higher-layer parameter configuration.

In one embodiment, the first information block comprises one or more Information Elements (IEs) comprised by an RRC layer signaling, or the first information block comprises one or more fields comprised by an RRC layer signaling.

In one embodiment, the second information block comprises one or more IEs comprised in an RRC signaling, or the first information block comprises one or more fields comprised in an RRC layer signaling.

In one embodiment, the second information block comprises part of or all fields comprised by a Master Information Block (MIB).

In one embodiment, the second information block comprises part of or all fields comprised by a System Information Block (SIB).

In one embodiment, a physical layer channel occupied by the second information block includes a PDCCH.

In one embodiment, the second information block is transmitted via a MAC CE.

In one embodiment, the second information block is transmitted via a physical layer dynamic signaling.

In one embodiment, the second information block is UE specific or UE dedicated.

In one embodiment, the second information block is Cell Common or Cell specific.

In one embodiment, the second information block comprises physical layer control information or physical layer control parameters.

In one embodiment, the second information block comprises part of or all fields in a Downlink Control Information (DCI) Format.

In one embodiment, the second information block is transmitted through a Physical Downlink Control Channel (PDCCH).

In one embodiment, the second information block is specific to or dedicated to the target sub-band.

In one embodiment, the second information block is only used for configuring the target sub-band.

In one embodiment, the second information block is configured per subband.

In one embodiment, the second information block is dedicated to a sub-band other than the target sub-band which has a same ID or index as the target sub-band.

In one embodiment, the second information block is used for configuring a sub-band other than the target sub-band which has a same ID or index as the target sub-band.

In one embodiment, a sub-band other than the target sub-band which has a same ID or index as the target sub-band shares all or partial configuration parameters in the second information block with the target sub-band.

In one embodiment, the second information block comprises part of or all fields in an IE “BWP-Flexible”.

In one embodiment, the second information block comprises part of or all fields in an IE “BWP-Downlink”.

In one embodiment, the second information block comprises part of or all fields in an IE “BWP-Uplink”.

In one embodiment, the second information block comprises an IE other than an IE “BWP-Downlink” or an IE “BWP-Uplink”.

In one embodiment, a name of an RRC signaling used to transmit the second information block includes Slot.

In one embodiment, a name of an RRC signaling used to transmit the second information block includes SlotFormat.

In one embodiment, a name of an RRC signaling used to transmit the second information block includes Format.

In one embodiment, the second information block is transmitted via a MAC CE.

In one embodiment, a name of a MAC CE used to transmit the second information block includes Slot.

In one embodiment, a name of a MAC CE used to transmit the second information block includes SlotFormat.

In one embodiment, a name of a MAC CE used to transmit the second information block includes Format.

In one embodiment, the second information block is transmitted via a DCI.

In one embodiment, when the second information block is transmitted via a DCI, the format used by the DCI is DCI Format 2_0.

In one embodiment, the second information block is used to indicate that the slot format supported in the target sub-band is one of “D”, “U” or “F”.

In one embodiment, the statement of “the second information block comprising configuration information for a target sub-band” in the claims includes the following meaning: the second information block is used to determine the configuration information for the target sub-band.

In one embodiment, the statement of “the second information block comprising configuration information for a target sub-band” in the claims includes the following meaning: the second information block carries the configuration information for the target sub-band.

In one embodiment, the statement of “the second information block comprising configuration information for a target sub-band” in the claims includes the following meaning: one or more fields comprised by the second information block is/are used to explicitly or implicitly configure the target sub-band.

In one embodiment, the statement of “the first information block comprising configuration information for a target sub-band” in the claims includes the following meaning: the first information block is used to explicitly or implicitly indicate the value(s) of one or more configuration parameters of the target sub-band.

In one embodiment, a frequency-domain resource occupied by the target sub-band is smaller than a Bandwidth Part (BWP).

In one embodiment, a frequency-domain resource occupied by the target sub-band is a frequency-domain resource corresponding to a positive integer number of PRBs.

In one embodiment, a frequency-domain resource occupied by the target sub-band is a sub-band of multiple sub-bands comprised by a BWP; any of the multiple sub-bands occupies a frequency-domain resource corresponding to a positive integer number of PRBs.

In one embodiment, the target sub-band is a sub-band supporting Flexible or Variable Duplex.

In one embodiment, the target sub-band is a sub-band supporting both Uplink and Downlink.

In one embodiment, the target sub-band comprises at least one subcarrier.

In one embodiment, the target sub-band comprises at least one Physical Resource Block (PRB).

In one embodiment, all subcarriers comprised by the target sub-band belong to a same BWP.

In one embodiment, a BWP comprises the target sub-band.

In one embodiment, the target sub-band comprises multiple subcarriers, and any two subcarriers comprised by the target sub-band have equal subcarrier spacings.

In one embodiment, the target sub-band comprises multiple subcarriers, and two subcarriers comprised by the target sub-band have unequal subcarrier spacings.

In one embodiment, the target sub-band comprises contiguous frequency-domain resources.

In one embodiment, the target sub-band comprises discrete frequency-domain resources.

In one embodiment, the target sub-band comprises a Guard subcarrier or a Guard PRB.

In one embodiment, the target sub-band comprises subcarriers or PRBs unavailable for transmission or allocation.

In one embodiment, configuration information for the target sub-band comprises a type of the target sub-band or a type of a sub-band set to which the target sub-band belongs.

In one embodiment, configuration information for the target sub-band comprises a type of a BWP set to which the target sub-band belongs.

In one embodiment, configuration information for the target sub-band comprises a duplex type of the target sub-band or a duplex type of a sub-band set to which the target sub-band belongs.

In one embodiment, configuration information for the target sub-band comprises whether the target sub-band belongs to a sub-band set supporting multiple link directions.

In one embodiment, configuration information for the target sub-band comprises whether the target sub-band belongs to a BWP supporting multiple link directions.

In one embodiment, configuration information for the target sub-band comprises whether the target sub-band is a sub-band in Flexible or Variable Link or whether the target sub-band belongs to a sub-band set in Flexible Link (FL) or Variable Link (VL).

In one embodiment, configuration information for the target sub-band comprises whether the target sub-band belongs to a BWP in Flexible or Variable Link or whether the target sub-band belongs to a BWP set in Flexible Link (FL) or Variable Link (VL).

In one embodiment, configuration information for the target sub-band comprises whether the target sub-band supports a link direction of time-domain symbols configured as an uplink or a downlink by an IE “tdd-UL-DL-ConfigCommon” in being overridden.

In one embodiment, configuration information for the target sub-band comprises whether the target sub-band supports a link direction of time-domain symbols configured as an uplink or a downlink by an IE “tdd-UL-DL-ConfigDedicated” in being overridden.

In one embodiment, configuration information for the target sub-band comprises at least one of location information of the target sub-band in frequency domain or a link direction indicator of the target sub-band.

In one embodiment, configuration information for the target sub-band comprises at least one of location information of the target sub-band in frequency domain, a link direction indicator of the target sub-band, a subcarrier spacing (SCS) indication, a starting Common Resource Block (CRB) indicator, a number of CRBs comprised or a list of indexes of BWPs comprised.

In one embodiment, configuration information for the target sub-band comprises at least one of location information of the target sub-band in frequency domain, a link direction indicator of the target sub-band, a subcarrier spacing (SCS) indication, a position of a starting PRB in a BWP to which the target sub-band belongs, a number of PRBs comprised or an index or identifier of the BWP to which the target sub-band belongs.

In one embodiment, configuration information for the target sub-band comprises at least one of location information of the target sub-band in frequency domain, a link direction indicator of the target sub-band, a subcarrier spacing (SCS) indication, a position of a starting PRB in a BWP to which the starting PRB belongs, a position of an ending PRB in a BWP to which the ending PRB belongs, an index or identifier of the BWP to which the starting PRB belongs, or an index or identifier of the BWP to which the ending PRB belongs.

In one embodiment, configuration information for the target sub-band is configured by a signaling dedicated to the target sub-band.

In one embodiment, configuration information for the target sub-band is configured by a signaling dedicated to a sub-band group to which the target sub-band belongs.

In one embodiment, configuration information for the target sub-band is configured by a configuration signaling configured per subband.

In one embodiment, the third information block is transmitted via an RRC signaling.

In one embodiment, a name of an RRC signaling used to transmit the third information block includes Slot.

In one embodiment, a name of an RRC signaling used to transmit the third information block includes SlotFormat.

In one embodiment, a name of an RRC signaling used to transmit the third information block includes Format.

In one embodiment, the third information block is transmitted via a MAC CE.

In one embodiment, a name of a MAC CE used to transmit the third information block includes Slot.

In one embodiment, a name of a MAC CE used to transmit the third information block includes SlotFormat.

In one embodiment, a name of a MAC CE used to transmit the third information block includes Format.

In one embodiment, the third information block is transmitted via a DCI.

In one embodiment, when the third information block is transmitted via a DCI, the format used by the DCI is DCI Format 2_0.

In one embodiment, the third information block is configured per subband.

In one embodiment, the second information block and the third information block belong to two different Information Elements (IEs) in an RRC signaling, respectively.

In one embodiment, the second information block and the third information block belong to two fields in an IE in an RRC signaling.

In one embodiment, the second information block is configured per sub-band, a bandwidth of a frequency-domain resource occupied by the sub-band in frequency domain being smaller than that of a frequency-domain resource occupied by a bandwidth part.

### Embodiment 8

Embodiment 8 illustrates a flowchart of a synchronization signal, as shown in FIG. 8. In FIG. 8, a first node U7 and a second node N8 are in communication via a radio link. It should be particularly noted that the sequence illustrated herein does not set any limit to the signal transmission order or implementation order in the present application. In case of no conflict, the embodiments, subembodiments, and subsidiary embodiments in Embodiment 8 can be applied to any embodiment of Embodiments 5, 6, 7 and 9; conversely, in case of no conflict, the embodiments, subembodiments, and subsidiary embodiments in Embodiments 5, 6, 7 and 9 can be applied to Embodiment 8.

The first node U7 receives a synchronization signal in step S70; receives a third signal in a third time-frequency resource set in step S71; and receives a fourth signal in a fourth time-frequency resource set in step S72.

The second node N8 transmits a synchronization signal in step S80; transmits a third signal in a third time-frequency resource set in step S81; and transmits a fourth signal in a fourth time-frequency resource set in step S82.

In Embodiment 8, a frequency-domain resource occupied by the third time-frequency resource set and a frequency-domain resource occupied by the fourth time-frequency resource set both belong the first sub-band; a time-domain resource occupied by the third time-frequency resource set is the first time unit, while a time-domain resource occupied by the fourth time-frequency resource set is the second time unit; each of the first signal and the second signal comprises a channel state information reference signal (CSI-RS), and each of a physical layer channel occupied by the third signal and a physical layer channel occupied by the fourth signal comprises a physical downlink shared channel (PDSCH); an EPRE of the synchronization signal, a first offset value and the first value are used to determine an EPRE of the first signal; the EPRE of the synchronization signal and the first offset value are used to determine an EPRE of the second signal, and the first value is not used to determine the EPRE of the second signal; the EPRE of the first signal and a second offset value are used to determine an EPRE of the third signal, and the EPRE of the second signal and the second offset value are used to determine an EPRE of the fourth signal; a radio resource control (RRC) signaling is used to determine the first offset value and the second offset value.

In one embodiment, the step S70 in Embodiment 8 is located before the step S10 in Embodiment 5.

In one embodiment, the step S80 in Embodiment 8 is located before the step S20 in Embodiment 5.

In one embodiment, the step S71 in Embodiment 8 is located after the step S11 in Embodiment 5.

In one embodiment, the step S81 in Embodiment 8 is located after the step S21 in Embodiment 5.

In one embodiment, the step S72 in Embodiment 8 is located after the step S30 in Embodiment 6.

In one embodiment, the step S82 in Embodiment 8 is located after the step S40 in Embodiment 6.

In one embodiment, time-domain resources occupied by the first signal and time-domain resources occupied by the third signal belong to the first time unit simultaneously.

In one embodiment, the first signal and the third signal are Frequency Division Multiplexing (FDM).

In one embodiment, the first signal and the second signal are Time Division Multiplexing (TDM).

In one embodiment, time-domain resources occupied by the second signal and time-domain resources occupied by the fourth signal belong to the second time unit simultaneously.

In one embodiment, the second signal and the fourth signal are FDM.

In one embodiment, the third signal and the fourth signal are TDM.

In one embodiment, the synchronization signal comprises a SS/PBCH Block (SSB).

In one embodiment, the synchronization signal comprises a Primary Synchronization Signal (PSS).

In one embodiment, the synchronization signal comprises a Secondary Synchronization Signal (SSS).

In one embodiment, the EPRE of the synchronization signal is obtained by RRC signaling configuration.

In one embodiment, the EPRE of the synchronization signal is obtained by a parameter ss-PBCH-BlockPower.

In one embodiment, the first offset value is obtained by RRC signaling configuration.

In one embodiment, the first offset value is measured in dB.

In one embodiment, the first offset value is obtained by a parameter powerControlOffsetSS.

In one embodiment, the EPRE of the first signal is linearly correlated with the EPRE of the synchronization signal, the first offset value and the first value.

In one embodiment, the EPRE of the first signal is equal to the EPRE of the synchronization signal plus the first offset value minus the first value.

In one embodiment, the EPRE of the first signal is equal to the EPRE of the synchronization signal plus the first offset value plus the first value.

In one embodiment, the EPRE of the second signal is linearly correlated with the EPRE of the synchronization signal and the first offset value.

In one embodiment, the EPRE of the second signal is equal to the EPRE of the synchronization signal plus the first offset value.

In one embodiment, the second offset value is obtained by RRC signaling configuration.

In one embodiment, the second offset value is measured in dB.

In one embodiment, the second offset value is obtained by a parameter powerControlOffset.

In one embodiment, the first signal and the second signal are both CSI-RS, while the third signal and the fourth signal are both PDSCHs.

In one embodiment, the EPRE of the third signal is equal to a sum of the EPRE of the first signal and the second offset value.

In one embodiment, the EPRE of the fourth signal is equal to a sum of the EPRE of the second signal and the second offset value.

In one embodiment, the EPRE of the third signal is equal to a difference between the EPRE of the first signal and the second offset value.

In one embodiment, the EPRE of the fourth signal is equal to a difference between the EPRE of the second signal and the second offset value.

### Embodiment 9

Embodiment 9 illustrates a flowchart of a target information block, as shown in FIG. 9. In FIG. 9, a first node U9 and a second node N10 are in communication via a radio link. It should be particularly noted that the sequence illustrated herein does not set any limit to the signal transmission order or implementation order in the present application. In case of no conflict, the embodiments, subembodiments, and subsidiary embodiments in Embodiment 9 can be applied to any embodiment of Embodiments 5, 6, 7 and 8; conversely, in case of no conflict, the embodiments, subembodiments, and subsidiary embodiments in Embodiments 5, 6, 7 and 8 can be applied to Embodiment 9.

The first node U9 transmits a target information block in step S90.

The second node N10 transmits a target information block in step S100.

In Embodiment 10, the target information block comprises channel quality information, and both the first signal and the second signal are used to determine the channel quality information; when the first signal is used to determine the channel quality information, the first node U9 assumes that the transmit power value of the first signal is equal to the second power value.

In one embodiment, the step S90 in Embodiment 9 is located after the step S30 in Embodiment 6.

In one embodiment, the step S100 in Embodiment 9 is located after the step S40 in Embodiment 6.

In one embodiment, the step S90 in Embodiment 9 is located after the step S72 in Embodiment 8.

In one embodiment, the step S100 in Embodiment 9 is located after the step S82 in Embodiment 8.

In one embodiment, the target information block is transmitted through a Physical Uplink Shared Channel (PUSCH).

In one embodiment, the target information block is transmitted through a Physical Uplink Control Channel (PUCCH).

In one embodiment, the target information block is transmitted via Uplink Control Information (UCI).

In one embodiment, the channel quality information comprises channel quality between a transmitter of the first information block and the first node.

In one embodiment, the channel quality information is for the channel quality of wireless channels.

In one embodiment, the channel quality information comprises Channel state information (CSI).

In one embodiment, the channel quality information comprises Channel Quality Information (CQI).

In one embodiment, the channel quality information comprises a Precoding Matrix Indicator (PMI).

In one embodiment, the channel quality information comprises a Rank Indicator (RI).

In one embodiment, the channel quality information comprises a CSI-RS Resource Indicator (CRI).

In one embodiment, the channel quality information comprises a SS/PBCH Resource Block Indicator (SSBRI).

In one embodiment, the channel quality information comprises a Layer Indicator (LI).

In one embodiment, the channel quality information comprises Layer 1 Reference Signal Received Power (L1-RSRP).

In one embodiment, the meaning of the above phrase that when the first signal is used to determine the channel quality information, the first node U9 assumes that the transmit power value of the first signal is equal to the second power value includes: the power value of the first signal received by the first node U9 is equal to a first receive power value, the first node uses a second receive power value to determine the signal quality information, and the first receive power value and the first value are used to determine the second receive power value.

In one subembodiment, the second receive power value is equal to the first receive power value plus the first value.

In one subembodiment, the second receive power value is equal to the first receive power value minus the first value.

In one subembodiment, the second receive power value is linearly correlated to the first receive power value and the first value.

In one embodiment, the meaning of the above phrase that when the first signal is used to determine the channel quality information, the first node U9 assumes that the transmit power value of the first signal is equal to the second power value includes: the first node U9 determines an equivalent receive power value of the first signal in accordance with the second power value, and an actual receive power value of the first signal, and determines the signal quality information based on the equivalent power value, the actual receive power value and the first value being used to determine the equivalent receive power value.

In one subembodiment, the equivalent receive power value is equal to the actual receive power value plus the first value.

In one subembodiment, the equivalent receive power value is equal to the actual receive power value minus the first value.

In one subembodiment, the equivalent receive power value is linearly correlated to the actual receive power value and the first value.

### Embodiment 10

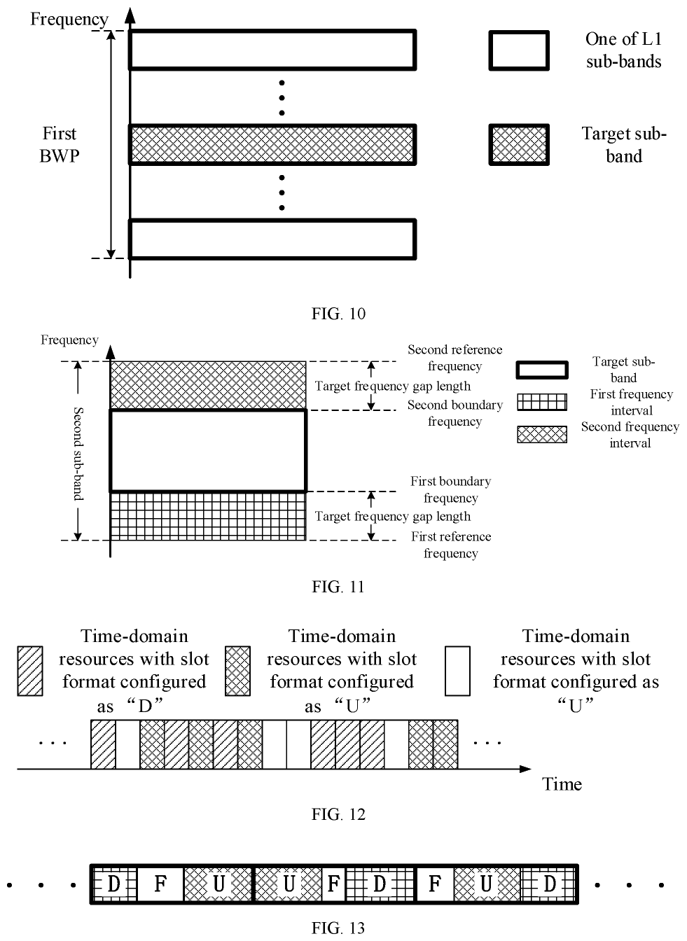

Embodiment 10 illustrates a schematic diagram of a target sub-band, as shown in FIG. 10. In FIG. 10, a first BWP comprises L1 sub-bands, L1 being a positive integer greater than 1, the target sub-band being one of the L1 sub-bands; the number of RBs included in any of the L1 sub-bands being a positive integer greater than 1.

In one embodiment, each of the L1 sub-bands comprises L2 resource blocks, L2 being fixed, or L2 being configured by RRC signaling.

In one embodiment, at least two of the L1 sub-bands comprise different numbers of resource blocks.

In one embodiment, at least one of the L1 sub-bands is configured for downlink transmission only.

In one embodiment, the slot format of at least one of the L1 sub-bands is configured as “D”.

In one embodiment, at least one of the L1 sub-bands is configured for uplink transmission only.

In one embodiment, the slot format of at least one of the L1 sub-bands is configured as “U”.

In one embodiment, at least one of the L1 sub-bands is configured as a variable duplex link direction.

In one embodiment, at least one of the L1 sub-bands is configured as a flexible link direction.

In one embodiment, the slot format of at least one of the L1 sub-bands is configured as “F”.

In one embodiment, the slot format of the target sub-band is configured as “F”.

In one embodiment, the first sub-band is a sub-band among the L1 sub-bands.

In one embodiment, the first sub-band is the target sub-band.

In one embodiment, the first sub-band is a sub-band of the L1 sub-bands other than the target sub-band.

### Embodiment 11

Embodiment 11 illustrates a schematic diagram of a target sub-band according to another embodiment of the present application, as shown in FIG. 11. In FIG. 11, the vertical axis represents frequency, and the thick-line framed rectangle with no filling represents a target sub-band, and the reticle-filled rectangle represents a first frequency interval, and the cross-filled rectangle represents a second frequency interval.

In Embodiment 11, a first boundary frequency is equal to a lowest boundary frequency of the target sub-band in this application, and a second boundary frequency is equal to a highest boundary frequency of the target sub-band; a first reference frequency is equal to the difference between the first boundary frequency and a target frequency gap length, and a second reference frequency is equal to the sum of the second boundary frequency and the target frequency gap length; a first frequency interval is a frequency interval from the first boundary frequency to the first reference frequency, and the second frequency interval is a frequency interval from the second reference frequency to the second boundary frequency; the locational relation in frequency domain between the first time-frequency resource set and the first frequency interval or the second frequency interval is used to determine the target reference signal resource set from the M1 reference signal resource sets in the present application.

In one embodiment, frequency-domain resources between the first reference frequency and the second reference frequency correspond to the second sub-band in the present application.

In one embodiment, a relation between the first sub-band and the target sub-band includes a locational relation between the first sub-band and the first frequency interval or the second frequency interval.

In one embodiment, the first boundary frequency is a lowest frequency point of the target sub-band.

In one embodiment, the first boundary frequency is a lowest frequency that can be comprised by the target sub-band.

In one embodiment, the second boundary frequency is a highest frequency point of the target sub-band.

In one embodiment, the second boundary frequency is a highest frequency that can be comprised by the target sub-band.

In one embodiment, a difference between the second boundary frequency and the first boundary frequency is equal to a bandwidth of the target sub-band.

In one embodiment, the target frequency gap length is greater than 0.

In one embodiment, the target frequency gap length is equal to 4 MHz.

In one embodiment, the target frequency gap length is equal to 8 MHz.

In one embodiment, the target frequency gap length is pre-defined.

In one embodiment, the target frequency gap length is explicitly or implicitly configured.

In one embodiment, a relation between the first sub-band and the target sub-band includes: whether the first sub-band comprises, in the frequency domain, at least one subcarrier belonging to one of the first frequency interval or the second frequency interval.

In one subembodiment, the first sub-band in frequency domain comprises at least one subcarrier belonging to one of the first frequency interval or the second frequency interval, the first value being used to determine the first power value; any subcarrier comprised by the first sub-band in frequency domain belongs to neither of the first frequency interval or the second frequency interval, the first value not being used to determine the first power value.

In one embodiment, a relation between the first sub-band and the target sub-band includes: whether the first sub-band is orthogonal to any one of the first frequency interval or the second frequency interval in frequency domain.

In one subembodiment, the first sub-band in frequency domain is overlapping with at least one of the first frequency interval or the second frequency interval, the first value being used to determine the first power value; or the first sub-band in frequency domain is orthogonal to any of the first frequency interval or the second frequency interval, the first value not being used to determine the first power value.

In one embodiment, a relation between the first sub-band and the target sub-band includes: whether the first sub-band is confined in the first frequency interval or the second frequency interval in frequency domain.

In one subembodiment, the first sub-band in frequency domain is confined in at least one of the first frequency interval or the second frequency interval, the first value being used to determine the first power value; or the first sub-band in frequency domain is not confined to any of the first frequency interval or the second frequency interval, the first value not being used to determine the first power value.

In one embodiment, a relation between the first sub-band and the target sub-band includes: whether the first frequency interval or the second frequency interval includes any resource block comprised by the first sub-band in the frequency domain.

In one subembodiment, the first frequency interval or the second frequency interval includes any resource block comprised by the first sub-band in the frequency domain, the first value being used to determine the first power value; the first frequency interval or the second frequency interval does not include any resource block comprised by the first sub-band in the frequency domain, the first value not being used to determine the first power value.

In one embodiment, a relation between the first sub-band and the target sub-band includes: whether any resource block comprised by the first sub-band in the frequency domain is included in the first frequency interval or the second frequency interval.

In one subembodiment, any resource block comprised by the first sub-band in the frequency domain is included in the first frequency interval or the second frequency interval, the first value being used to determine the first power value; or at least one resource block comprised by the first sub-band in the frequency domain is not included in the first frequency interval or the second frequency interval, the first value not being used to determine the first power value.

### Embodiment 12

Embodiment 12 illustrates a schematic diagram of the slot format of a first time unit, as shown in FIG. 12.

In FIG. 12, a rectangle filled with oblique lines indicates a time-domain resource configured as “D”; a rectangle filled with diagonal grids indicates a time-domain resource configured as “U”; and an unfilled rectangle indicates a time-domain resource configured as “F”.

In one embodiment, when the time-domain resource occupied by the first time unit belongs to a time-domain resource configured as “D”, the first value is not used to determine the first power value; when the time-domain resource occupied by the first time unit belongs to a time-domain resource configured as “F”, the first value is used to determine the first power value.

In one embodiment, when the time-domain resource occupied by the first time unit belongs to a time-domain resource configured as “U”, the first value is not used to determine the first power value; when the time-domain resource occupied by the first time unit belongs to a time-domain resource configured as “F”, the first value is used to determine the first power value.

### Embodiment 13

Embodiment 13 illustrates a schematic diagram of the slot format of a target sub-band, as shown in FIG. 13. In FIG. 13, each thick-line framed rectangle represents a time-frequency resource occupied by a slot in the target sub-band, and each reticle-filled rectangle represents at least one Downlink (D) time-domain symbol, and each cross-filled rectangle represents at least one Uplink (U) time-domain symbol, and each blank rectangle represents at least one Flexible (F) time-domain symbol.

In one embodiment, the scenario shown in the figure is one in which the target sub-band is configured as a variable duplex link direction.

In one embodiment, the scenario shown in the figure is one in which the target sub-band is configured as a flexible link direction.

In one embodiment, the scenario shown in the figure is one in which the target sub-band is configured as “F”.

### Embodiment 14

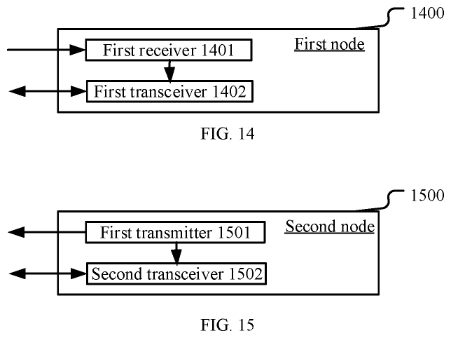

Embodiment 14 illustrates a structure block diagram of a first node, as shown in FIG. 14. In FIG. 14, a first node 1400 comprises a first receiver 1401 and a first transceiver 1402.

The first receiver 1401 receives a first information block, the first information block indicating a first value;

the first transceiver 1402 receives a first signal in a first time-frequency resource set, a transmit power value of the first signal being a first power value.

In Embodiment 14, a time-domain resource occupied by the first time-frequency resource set is a first time unit, and a frequency-domain resource occupied by the first time-frequency resource set belongs to a first sub-band; at least one of a slot format corresponding to the first time unit or a relation of the first sub-band and a target sub-band is used to determine whether the first value is used to determine the first power value; configuration information for the target sub-band is used to at least determine a slot format for the target sub-band.

In one embodiment, the first transceiver 1402 receives a second signal in a second time-frequency resource set; a transmit power value of the second signal is a second power value, the second power value being linear with both the first power value and the first value; a frequency-domain resource occupied by the second time-frequency resource set belongs to the first sub-band, and a time-domain resource occupied by the second time-frequency resource set is a second time unit, the second time unit and the first time unit being orthogonal in time domain; the first signal and the second signal occupy a same type of physical layer channel.

In one embodiment, the first receiver 1401 receives a second information block; the second information block is used to indicate the configuration information for the target sub-band, the slot format for the target sub-band includes the target sub-band supporting transmissions in multiple links, or the slot format for the target sub-band includes symbols in the target sub-band supporting a flexible or variable duplex slot format.

In one embodiment, the first receiver 1401 receives a third information block; the third information block is used to indicate the slot format corresponding to the first time unit.

In one embodiment, the slot format corresponding to the first time unit is used to determine whether the first value is used to determine the first power value; when the slot format corresponding to the first time unit supports flexible or variable duplex, the first value is used to determine the first power value; when the slot format corresponding to the first time unit does not support flexible or variable duplex, the first value is not used to determine the first power value.

In one embodiment, the relation of the first sub-band and the target sub-band is used to determine whether the first value is used to determine the first power value; a frequency-domain location of the target sub-band is used to determine a second sub-band; when there is an overlap between the first sub-band and the second sub-band, the first value is used to determine the first power value; when there is no overlap between the first sub-band and the second sub-band, the first value is not used to determine the first power value.

In one embodiment, the second information block is configured per sub-band, a bandwidth of a frequency-domain resource occupied by the sub-band in frequency domain being smaller than that of a frequency-domain resource occupied by a bandwidth part.

In one embodiment, the first receiver 1401 receives a synchronization signal, the first transceiver 1402 receives a third signal in a third time-frequency resource set, and the first transceiver 1402 receives a fourth signal in a fourth time-frequency resource set; a frequency-domain resource occupied by the third time-frequency resource set and a frequency-domain resource occupied by the fourth time-frequency resource set both belong the first sub-band; a time-domain resource occupied by the third time-frequency resource set is the first time unit, while a time-domain resource occupied by the fourth time-frequency resource set is the second time unit; each of the first signal and the second signal comprises a channel state information reference signal (CSI-RS), and each of a physical layer channel occupied by the third signal and a physical layer channel occupied by the fourth signal comprises a physical downlink shared channel (PDSCH); an EPRE of the synchronization signal, a first offset value and the first value are used to determine an EPRE of the first signal; the EPRE of the synchronization signal and the first offset value are used to determine an EPRE of the second signal, and the first value is not used to determine the EPRE of the second signal; the EPRE of the first signal and a second offset value are used to determine an EPRE of the third signal, and the EPRE of the second signal and the second offset value are used to determine an EPRE of the fourth signal; a radio resource control (RRC) signaling is used to determine the first offset value and the second offset value.

In one embodiment, the first transceiver 1402 transmits a target information block; the target information block comprises channel quality information, and both the first signal and the second signal are used to determine the channel quality information; when the first signal is used to determine the channel quality information, the first node assumes that the transmit power value of the first signal is equal to the second power value.

In one embodiment, the target sub-band supports transmissions of V2X.

In one embodiment, the first receiver 1401 comprises at least the first four of the antenna 452, the receiver 454, the multi-antenna receiving processor 458, the receiving processor 456 and the controller/processor 459 in Embodiment 4.

In one embodiment, the first transceiver 1402 comprises at least the first six of the antenna 452, the receiver/transmitter 454, the multi-antenna receiving processor 458, the multi-antenna transmitting processor 457, the receiving processor 456, the transmitting processor 468 and the controller/processor 459 in Embodiment 4.

In one embodiment, the first information block is an RRC signaling; when the slot format corresponding to the first time unit is “F”, the first value is used to determine the first power value; when the slot format corresponding to the first time unit is not “F”, the first value is not used to determine the first power value.

In one embodiment, the first information block is an RRC signaling; when the first sub-band and the target sub-band are overlapped, the first value is used to determine the first power value; when the first sub-band and the target sub-band are orthogonal, the first value is not used to determine the first power value.

In one embodiment, the first information block is an RRC signaling; when the slot format corresponding to the first time unit is “F” and the first sub-band and the target sub-band are overlapped, the first value is used to determine the first power value; otherwise, the first value is not used to determine the first power value.

### Embodiment 15

Embodiment 15 illustrates a structure block diagram of a second node, as shown in FIG. 15. In FIG. 15, a second node 1500 comprises a first transmitter 1501 and a second transceiver 1502.

The first transmitter 1501 transmits a first information block, the first information block indicating a first value;
the second transceiver 1502 transmits a first signal in a first time-frequency resource set, a transmit power value of the first signal being a first power value.

In Embodiment 15, a time-domain resource occupied by the first time-frequency resource set is a first time unit, and a frequency-domain resource occupied by the first time-frequency resource set belongs to a first sub-band; at least one of a slot format corresponding to the first time unit or a relation of the first sub-band and a target sub-band is used to determine whether the first value is used to determine the first power value; configuration information for the target sub-band is used to at least determine a slot format for the target sub-band.

In one embodiment, the second transceiver 1502 transmits a second signal in a second time-frequency resource set; a transmit power value of the second signal is a second power value, the second power value being linear with both the first power value and the first value; a frequency-domain resource occupied by the second time-frequency resource set belongs to the first sub-band, and a time-domain resource occupied by the second time-frequency resource set is a second time unit, the second time unit and the first time unit being orthogonal in time domain; the first signal and the second signal occupy a same type of physical layer channel.

In one embodiment, the first transmitter 1501 transmits a second information block; the second information block is used to indicate the configuration information for the target sub-band, the slot format for the target sub-band includes the target sub-band supporting transmissions in multiple links, or the slot format for the target sub-band includes symbols in the target sub-band supporting a flexible or variable duplex slot format.

In one embodiment, the first transmitter 1501 transmits a third information block; the third information block is used to indicate the slot format corresponding to the first time unit.

In one embodiment, the slot format corresponding to the first time unit is used to determine whether the first value is used to determine the first power value; when the slot format corresponding to the first time unit supports flexible or variable duplex, the first value is used to determine the first power value; when the slot format corresponding to the first time unit does not support flexible or variable duplex, the first value is not used to determine the first power value.

In one embodiment, the relation of the first sub-band and the target sub-band is used to determine whether the first value is used to determine the first power value; a frequency-domain location of the target sub-band is used to determine a second sub-band; when there is an overlap between the first sub-band and the second sub-band, the first value is used to determine the first power value; when there is no overlap between the first sub-band and the second sub-band, the first value is not used to determine the first power value.

In one embodiment, the second information block is configured per sub-band, a bandwidth of a frequency-domain resource occupied by the sub-band in frequency domain being smaller than that of a frequency-domain resource occupied by a bandwidth part.

In one embodiment, the first transmitter 1501 transmits a synchronization signal, the second transceiver 1502 transmits a third signal in a third time-frequency resource set, and the second transceiver 1502 transmits a fourth signal in a fourth time-frequency resource set; a frequency-domain resource occupied by the third time-frequency resource set and a frequency-domain resource occupied by the fourth time-frequency resource set both belong the first sub-band; a time-domain resource occupied by the third time-frequency resource set is the first time unit, while a time-domain resource occupied by the fourth time-frequency resource set is the second time unit; each of the first signal and the second signal comprises a channel state information reference signal (CSI-RS), and each of a physical layer channel occupied by the third signal and a physical layer channel occupied by the fourth signal comprises a physical downlink shared channel (PDSCH); an EPRE of the synchronization signal, a first offset value and the first value are used to determine an EPRE of the first signal; the EPRE of the synchronization signal and the first offset value are used to determine an EPRE of the second signal, and the first value is not used to determine the EPRE of the second signal; the EPRE of the first signal and a second offset value are used to determine an EPRE of the third signal, and the EPRE of the second signal and the second offset value are used to determine an EPRE of the fourth signal; a radio resource control (RRC) signaling is used to determine the first offset value and the second offset value.

In one embodiment, the second transceiver 1502 receives a target information block; the target information block comprises channel quality information, and both the first signal and the second signal are used to determine the channel quality information; when the first signal is used to determine the channel quality information, the first node assumes that the transmit power value of the first signal is equal to the second power value.

In one embodiment, the first transmitter 1501 comprises at least the first four of the antenna 420, the transmitter 418, the multi-antenna transmitting processor 471, the transmitting processor 415 and the controller/processor 475 in Embodiment 4.

In one embodiment, the second transceiver 1502 comprises at least the first six of the antenna 420, the transmitter/receiver 418, the multi-antenna transmitting processor 471, the multi-antenna receiving processor 472, the transmitting processor 416, the receiving processor 470 and the controller/processor 475 in Embodiment 4.

In one embodiment, the first information block is an RRC signaling; when the slot format corresponding to the first time unit is “F”, the first value is used to determine the first power value; when the slot format corresponding to the first time unit is not “F”, the first value is not used to determine the first power value.

In one embodiment, the first information block is an RRC signaling; when the first sub-band and the target sub-band are overlapped, the first value is used to determine the first power value; when the first sub-band and the target sub-band are orthogonal, the first value is not used to determine the first power value.

In one embodiment, the first information block is an RRC signaling; when the slot format corresponding to the first time unit is “F” and the first sub-band and the target sub-band are overlapped, the first value is used to determine the first power value; otherwise, the first value is not used to determine the first power value.

The ordinary skill in the art may understand that all or part of steps in the above method may be implemented by instructing related hardware through a program. The program may be stored in a computer readable storage medium, for example Read-Only-Memory (ROM), hard disk or compact disc, etc. Optionally, all or part of steps in the above embodiments also may be implemented by one or more integrated circuits. Correspondingly, each module unit in the above embodiment may be realized in the form of hardware, or in the form of software function modules. The present application is not limited to any combination of hardware and software in specific forms. The first node in the present application includes but is not limited to mobile phones, tablet computers, notebooks, network cards, low-consumption equipment, enhanced MTC (eMTC) terminals, NB-IOT terminals, vehicle-mounted communication equipment, vehicles, automobiles, RSU, aircrafts, airplanes, unmanned aerial vehicles, telecontrolled aircrafts, etc. The second node in the present application includes but is not limited to macro-cellular base stations, micro-cellular base stations, home base stations, relay base station, eNB, gNB, Transmitter Receiver Point (TRP), GNSS, relay satellite, satellite base station, airborne base station, RSU, unmanned ariel vehicle, test equipment like transceiving device simulating partial functions of base station or signaling tester, and other radio communication equipment.

It will be appreciated by those skilled in the art that this disclosure can be implemented in other designated forms without departing from the core features or fundamental characters thereof. The currently disclosed embodiments, in any case, are therefore to be regarded only in an illustrative, rather than a restrictive sense. The scope of invention shall be determined by the claims attached, rather than according to previous descriptions, and all changes made with equivalent meaning are intended to be included therein.

What is claimed is:

1. A first node for wireless communications, comprising:
a first receiver, receiving a first information block, the first information block indicating a first value; and
a first transceiver, receiving a first signal in a first time-frequency resource set, a transmit power value of the first signal being a first power value;
wherein a time-domain resource occupied by the first time-frequency resource set is a first time unit, and a frequency-domain resource occupied by the first time-frequency resource set belongs to a first sub-band; at least one of a slot format corresponding to the first time unit or a relation of the first sub-band and a target sub-band is used to determine whether the first value is used to determine the first power value; configuration information for the target sub-band is used to at least determine a slot format for the target sub-band.

2. The first node according to claim 1, characterized in that the first transceiver receives a second signal in a second time-frequency resource set; a transmit power value of the second signal is a second power value, the second power value being linear with both the first power value and the first value; a frequency-domain resource occupied by the second time-frequency resource set belongs to the first sub-band, and a time-domain resource occupied by the second time-frequency resource set is a second time unit, the second time unit and the first time unit being orthogonal in time domain; the first signal and the second signal occupy a same type of physical layer channel.

3. The first node according to claim 1, characterized in that the first receiver receives a second information block; the second information block is used to indicate the configuration information for the target sub-band, the slot format for the target sub-band includes the target sub-band supporting transmissions in multiple links, or the slot format for the target sub-band includes symbols in the target sub-band supporting a flexible or variable duplex slot format.

4. The first node according to claim 1, characterized in that the first receiver receives a third information block; the third information block is used to indicate the slot format corresponding to the first time unit.

5. The first node according to claim 1, characterized in that the slot format corresponding to the first time unit is used to determine whether the first value is used to determine the first power value; when the slot format corresponding to the first time unit supports flexible or variable duplex, the first value is used to determine the first power value; when the slot format corresponding to the first time unit does not support flexible or variable duplex, the first value is not used to determine the first power value.

6. The first node according to claim 1, characterized in that the relation of the first sub-band and the target sub-band is used to determine whether the first value is used to determine the first power value; a frequency-domain location of the target sub-band is used to determine a second sub-band; when there is an overlap between the first sub-band and the second sub-band, the first value is used to determine the first power value; when there is no overlap between the first sub-band and the second sub-band, the first value is not used to determine the first power value.

7. The first node according to claim 1, characterized in that the second information block is configured per sub-band, a bandwidth of a frequency-domain resource occupied by the sub-band in frequency domain being smaller than that of a frequency-domain resource occupied by a bandwidth part.

8. The first node according to claim 2, characterized in that the first receiver receives a synchronization signal, the first transceiver receives a third signal in a third time-frequency resource set, and the first transceiver receives a fourth signal in a fourth time-frequency resource set; a frequency-domain resource occupied by the third time-frequency resource set and a frequency-domain resource occupied by the fourth time-frequency resource set both belong the first sub-band; a time-domain resource occupied by the third time-frequency resource set is the first time unit, while a time-domain resource occupied by the fourth time-frequency resource set is the second time unit; each of the first signal and the second signal comprises a channel state information reference signal (CSI-RS), and each of a physical layer channel occupied by the third signal and a physical layer channel occupied by the fourth signal comprises a physical downlink shared channel (PDSCH); an Energy Per Resource Element (EPRE) of the synchronization signal, a first offset value and the first value are used to determine an EPRE of the first signal; the EPRE of the synchronization signal and the first offset value are used to determine an EPRE of the second signal, and the first value is not used to determine the EPRE of the second signal; the EPRE of the first signal and a second offset value are used to determine an EPRE of the third signal, and the EPRE of the second signal and the second offset value are used to determine an EPRE of the fourth signal; a radio resource control (RRC) signaling is used to determine the first offset value and the second offset value.

9. The first node according to claim 2, characterized in that the first transceiver transmits a target information block; the target information block comprises channel quality information, and both the first signal and the second signal are used to determine the channel quality information; when the first signal is used to determine the channel quality information, the first node assumes that the transmit power value of the first signal is equal to the second power value.

10. A second node for wireless communications, comprising:
a first transmitter, transmitting a first information block, the first information block indicating a first value; and
a second transceiver, transmitting a first signal in a first time-frequency resource set, a transmit power value of the first signal being a first power value;
wherein a time-domain resource occupied by the first time-frequency resource set is a first time unit, and a frequency-domain resource occupied by the first time-frequency resource set belongs to a first sub-band; at least one of a slot format corresponding to the first time unit or a relation of the first sub-band and a target sub-band is used to determine whether the first value is used to determine the first power value; configuration information for the target sub-band is used to at least determine a slot format for the target sub-band.

11. The second node according to claim 10, characterized in that the second transceiver transmits a second signal in a second time-frequency resource set; a transmit power value of the second signal is a second power value, the second power value being linear with both the first power value and the first value; a frequency-domain resource occupied by the second time-frequency resource set belongs to the first sub-band, and a time-domain resource occupied by the second time-frequency resource set is a second time unit, the second time unit and the first time unit being orthogonal in time domain; the first signal and the second signal occupy a same type of physical layer channel.

12. The second node according to claim 10, characterized in that the first transmitter transmits a second information block; the second information block is used to indicate the configuration information for the target sub-band, the slot format for the target sub-band includes the target sub-band supporting transmissions in multiple links, or the slot format for the target sub-band includes symbols in the target sub-band supporting a flexible or variable duplex slot format.

13. The second node according to claim 10, characterized in that the first transmitter transmits a third information block; the third information block is used to indicate the slot format corresponding to the first time unit.

14. The second node according to claim 10, characterized in that the slot format corresponding to the first time unit is used to determine whether the first value is used to determine the first power value; when the slot format corresponding to the first time unit supports flexible or variable duplex, the first value is used to determine the first power value;
when the slot format corresponding to the first time unit does not support flexible or variable duplex, the first value is not used to determine the first power value.

15. The second node according to claim 10, characterized in that the relation of the first sub-band and the target sub-band is used to determine whether the first value is used to determine the first power value; a frequency-domain location of the target sub-band is used to determine a second sub-band; when there is an overlap between the first sub-band and the second sub-band, the first value is used to determine the first power value; when there is no overlap between the first sub-band and the second sub-band, the first value is not used to determine the first power value.

16. The second node according to claim 10, characterized in that the second information block is configured per sub-band, a bandwidth of a frequency-domain resource occupied by the sub-band in frequency domain being smaller than that of a frequency-domain resource occupied by a bandwidth part.

17. The second node according to claim 11, characterized in that the first transmitter transmits a synchronization signal, the second transceiver transmits a third signal in a third time-frequency resource set, and the second transceiver transmits a fourth signal in a fourth time-frequency resource set; a frequency-domain resource occupied by the third time-frequency resource set and a frequency-domain resource occupied by the fourth time-frequency resource set both belong the first sub-band; a time-domain resource occupied by the third time-frequency resource set is the first time unit, while a time-domain resource occupied by the fourth time-frequency resource set is the second time unit; each of the first signal and the second signal comprises a channel state information reference signal (CSI-RS), and each of a physical layer channel occupied by the third signal and a physical layer channel occupied by the fourth signal comprises a physical downlink shared channel (PDSCH); an EPRE of the synchronization signal, a first offset value and the first value are used to determine an EPRE of the first signal; the EPRE of the synchronization signal and the first offset value are used to determine an EPRE of the second signal, and the first value is not used to determine the EPRE of the second signal; the EPRE of the first signal and a second offset value are used to determine an EPRE of the third signal, and the EPRE of the second signal and the second offset value are used to determine an EPRE of the fourth signal; a radio resource control (RRC) signaling is used to determine the first offset value and the second offset value.

18. The second node according to claim 11, characterized in that the second transceiver receives a target information block; the target information block comprises channel quality information, and both the first signal and the second signal are used to determine the channel quality information; when the first signal is used to determine the channel quality information, a transmitter of the target information block assumes that the transmit power value of the first signal is equal to the second power value.

19. A method in a first node for wireless communications, comprising:
receiving a first information block, the first information block indicating a first value; and
receiving a first signal in a first time-frequency resource set, a transmit power value of the first signal being a first power value;
wherein a time-domain resource occupied by the first time-frequency resource set is a first time unit, and a frequency-domain resource occupied by the first time-frequency resource set belongs to a first sub-band; at least one of a slot format corresponding to the first time unit or a relation of the first sub-band and a target sub-band is used to determine whether the first value is used to determine the first power value; configuration information for the target sub-band is used to at least determine a slot format for the target sub-band.

20. The method in the first node according to claim 19, comprising:
receiving a second signal in a second time-frequency resource set;
wherein a transmit power value of the second signal is a second power value, the second power value being linear with both the first power value and the first value; a frequency-domain resource occupied by the second time-frequency resource set belongs to the first sub-band, and a time-domain resource occupied by the second time-frequency resource set is a second time unit, the second time unit and the first time unit being orthogonal in time domain; the first signal and the second signal occupy a same type of physical layer channel.
